(19) United States
(12) Patent Application Publication
(10) Pub. No.: US 2011/0257893 A1
(43) Pub. Date: Oct. 20, 2011

(54) METHODS FOR CLASSIFYING SAMPLES BASED ON NETWORK MODULARITY

(76) Inventors: Ian Taylor, Toronto (CA); Jeff Wrana, Toronto (CA)

(21) Appl. No.: 13/123,138

(22) PCT Filed: Oct. 9, 2009
(86) PCT No.: PCT/CA2009/001449

§ 371 Date: Jul. 5, 2011

Related U.S. Application Data
(60) Provisional application No. 61/104,328, filed on Oct. 10, 2008.

(51) Int. Cl. G06F 19/00

(52) U.S. Cl. 702/19

(57) ABSTRACT

Methods for classifying samples are based on alterations in network modularity. The methods are useful for the diagnosis, prognosis and monitoring of a biological state such as a disease state. In certain embodiments, methods for diagnosing disease or evaluating the prognosis of disease or identification of a disease state are computer-implemented.

### FIELD OF THE INVENTION

The invention relates to methods for classifying samples based on alterations in network modularity. The methods may be useful for the diagnosis, prognosis and monitoring of a biological state such as a disease state.

### BACKGROUND OF THE INVENTION

Genome-scale technologies are being utilized to understand complex diseases such as cancer¹. In particular, transcriptome analyses have been extensively applied as molecular diagnostic and prognostic tools in breast cancer. This has revealed clusters of gene expression signatures, such as the 70 gene prognostic², Luminal/Basal³ and Wound⁴ signatures that have prognostic value. Interestingly, these different signatures have little overlap, yet when used to examine the same set of patients, they yield comparable prognostic results. This has led to the suggestion that each signature is capturing a portion of the alterations in the global transcriptome that result in poor prognosis in breast cancer⁵.

High throughput technologies have also been applied to the development of proteome wide maps of protein-protein interaction networks (interactomes). Interactome data has subsequently been employed to identify proteins associated with the breast cancer tumor suppressor BRCA1, thus identifying the centrosome component HMMR, a polymorphism of which is associated with breast cancer risk⁶. Furthermore, integration of the interactome with the 70 gene expression signature was recently employed to expand the signature, resulting in increased prognostic performance in breast cancer⁷.

There remains a need in the art for new and effective methods to diagnose disease, provide an evaluation of disease progression and prognosis, as well as to identify new methods and compositions for use in distinguishing between disease states.

### SUMMARY OF THE INVENTION

We have demonstrated that human protein-protein interaction networks or interactomes are composed of hub proteins that are co-expressed with their interacting partners only in some tissues (intermodular hubs) and hubs that are more frequently co-expressed with their partners (intramodular hubs). Significant differences in domain, linear motifs and phosphorylation site structure were observed between the hub classes, and signalling domains were more often found in intermodular hub proteins which are more frequently associated with oncogenesis. We also found that alterations in network modularity of the interactome are associated with different biological states. Using methods developed and described by the inventors herein, it is possible to identify hubs that can significantly discriminate between biological states.

The inventors also investigated how altered gene expression profiles in a disease state (e.g. breast cancer) disturb the global organization of the human interactome. They found that the modular assembly of the human interactome is altered as a function of disease outcome and they demonstrate that analysis of dynamic network modularity predicts disease states. The methods rely on measurements of co-expression levels of protein hubs and interacting partners. These levels are subjected to a polynomial analysis that yields a result indicative of prognosis, likelihood or reoccurrence, or the likelihood of responding to therapy.

Broadly stated, the present invention relates to a method of identifying hubs that significantly correlate with a class distinction between samples. In an aspect, the invention relates to a method of identifying hubs and their interacting partners that significantly correlate with a class distinction between samples comprising sorting hubs and their interacting partners (also referred to as “interactors”) by degree to which their presence or co-expression in the samples correlate with the class distinction, and determining whether the correlation is stronger than expected by chance. A hub whose expression correlates with a class distinction more strongly than expected by chance is an informative hub. The class distinction can be a known class and in an embodiment the class distinction is a biological state, in particular a disease state. A known class can also be a set of subjects, in particular subjects with a favourable prognosis or subjects with an unfavourable prognosis. Sorting hubs and interacting partners by the degree to which their co-expression in samples correlates with a class distinction can be carried out using conventional correlation analyses.

In an aspect, the invention relates to a method of identifying hubs and their interacting partners that significantly discriminate among biological states, in particular disease states, comprising obtaining a reference data set that can be clustered into different biological states and into interactions comprising hubs and their interacting partners characteristic of each biological state, and assessing differences in interactions for each biological state to identify informative hubs that significantly discriminate between the biological states; and optionally confirming informative hubs by searching for the hubs in databases of scientific literature for the biological states.

In an aspect, the invention provides a method for determining a biological state through the discovery and analysis of discriminatory data patterns or network signatures of co-expression of hubs and their interacting partners. Analytical methods are utilized to discover hidden discriminatory patterns or network signatures of co-expression of hubs and their interacting partners that are a subset of a larger reference data set and that classify a biological state. The methods of the invention may be used to distinguish two or more biological states in a reference data set and the resulting discriminatory patterns or reference network signatures may be used to classify unknown or test samples.

The invention provides sets of informative hubs and interacting partners and network signatures that distinguish classes, in particular biological states, more particularly disease states, and uses therefor. The invention also provides computer-readable data media or databases comprising informative hubs and interacting partners and network signatures that distinguish classes.

The invention further provides a method for distinguishing a class, in particular a biological state, more particularly a disease state, in a sample by determining differences in co-expression of informative hubs and their interacting partners in a sample from the subject compared with a standard or model. The methods may be used in the diagnosis, prognosis or monitoring of a disease, or to assess treatments or drug responsiveness.

The invention relates to a method of characterizing or classifying a sample from a subject (e.g. a biological sample), by detecting or quantitating in the sample amounts or levels of informative hubs and their interactors that are characteristic of a class, in particular a biological state, more particularly a disease state, the method comprising assaying for differential co-expression of the hubs and their interactors in the sample. The invention also relates to a method of characterizing or classifying a biological state, in particular a disease state, of a subject by detecting or quantitating in a sample from the subject amounts or levels of informative hubs and their interactors that are characteristic of a biological state, in particular a disease state, the method comprising assaying for differential co-expression of the hubs and their interactors in the sample. Co-expression of the hubs and their interactors can be assayed using techniques known in the art. The invention pertains to a method for classifying a sample obtained from an individual into a class (e.g. favorable or poor prognosis) comprising assessing the sample for co-expression of informative hubs and their interacting partners and classifying the sample as a function of expression of informative hubs and interacting partners with respect to a model.

In another aspect, a method for generating reference network signatures characteristic of biological states is provided, which comprises: (a) obtaining a reference data set that can be clustered into different biological states and which comprises expression data for hubs and their interacting partners; (b) clustering hubs and interacting partners by biological states and assessing differences in each interaction between a hub and interacting partners between biological states to identify informative hubs and their interacting partners that significantly discriminate between the biological states; and (c) obtaining reference network signatures of the co-expression of informative hubs and interacting partners characteristic of the biological states. In another aspect, such a method further comprises comparing the reference network signature with a network signature of the informative hubs and interacting partners in a sample from a patient to characterize or classify the biological state of the patient.

In a variety of aspects of the methods described herein, the biological state is a disease state. In certain aspects, the disease state is cancer. In other aspects, the cancer is breast cancer.

In another aspect, a method for screening a subject for a disease or disease stage or classifying a disease or disease stage in a subject is provided which comprises (a) obtaining a biological sample from a subject; (b) detecting the amount of co-expression of hubs and interacting partners characteristic of the disease or disease stage in the sample; and (c) comparing the amount detected to a predetermined standard or model. In embodiments, detection of amounts of co-expression of hubs and interacting partners associated with the disease or disease stage that differ significantly from the standard or model indicates the disease or disease stage. In other embodiments, detection of amounts of co-expression of hubs and interacting partners associated with the disease or disease stage that are substantially similar to the standard or model indicates the disease or disease stage.

In another aspect, a method for classifying a breast cancer patient according to prognosis is provided comprising: (a) comparing the levels of co-expression of hubs and interacting partners characteristic of breast cancer prognosis in a sample from the patient to levels of co-expression of the hubs and interacting partners in a reference population; and (b) classifying the patient according to prognosis of the breast cancer based on the similarity between the levels of co-expression in the sample and the reference population. In such a method, step (b) can include determining whether the similarity exceeds one or more predetermined threshold values of similarity. In another embodiment of this method further comprising assigning a therapeutic regimen to the patient.

In another aspect, a method of categorizing drug responsiveness in a population comprises (a) determining the expression levels of hubs and interacting partners for individuals in the population; (b) identifying a first group of individuals in the population that have a substantially similar response to the drug; (c) clustering the hubs and interacting partners by the drug response of the first group to generate a reference network signature indicating drug responses for the first group of individuals. In another embodiment, this method further comprises the steps of (d) identifying a second group of individuals having a substantially similar response to the drug which differs from the drug response of the first group; and (e) clustering the hubs and interacting partners by the drug response of the second group to generate a reference network signature indicating drug responses for the second group of individuals. In another embodiment, one may repeat steps (d) and (e) one or more times for an additional group or individuals having a substantially similar drug response that differs from other groups.

In another aspect, a method for assigning an individual to one of a plurality of categories in a clinical trial comprises determining for the individual co-expression of hubs and interacting partners in a sample from the individual; producing a network signature of informative hubs and their interacting partners; comparing the network signature with reference network signatures of reference populations that have different clinical categories; and assigning the individual to a category in the clinical trial based on correlation of the network signature with one or more reference network signature.

In another aspect, a business method is provided for obtaining regulatory review of a drug comprising: (a) determining hubs and their interacting partners that significantly discriminate among responders and non-responders to the drug; (b) using results from step (a) to determine whether a patient would benefit from administration of the drug; and (c) combining information from prior regulatory filings for the drug in combination with information from step (b) to support a new drug approval regulatory filing.

In other aspects, this invention provides computer systems, computer programs, computer-readable data media and laboratory robots or evaluating devices for implementing the methods described herein.

In another aspect, a method for diagnosing a subject for the presence of a biological state, a disease or disease stage comprises: (a) obtaining a biological sample from the subject; (b) detecting the expression levels of hub proteins and their interacting partners in the sample; (c) determining the relative expression of the hub proteins and their interacting partners in the sample; and (d) comparing the subject's relative expression to a standard or model, wherein a significant difference between the subject's relative expression and the standard or model indicates the biological state, disease or disease stage.

In another aspect, a method for diagnosing a subject for the presence of a biological state, a disease or disease stage comprises: (a) obtaining a biological sample from the subject; (b) detecting the expression levels of hub proteins and their interacting partners in the sample; (c) determining the relative expression of the hub proteins and their interacting partners in the sample; and (d) comparing the subject's relative expression to a standard or model, wherein substantial similarity between the subject's relative expression and the standard or model indicates the biological state, disease or disease stage.

In another aspect, a method for diagnosing a subject for the presence of a biological state, a disease or disease stage comprises: (a) obtaining a biological sample from the subject; (b) detecting the expression levels of a hub protein and an interacting partner in the sample; (c) determining the relative expression of the hub protein and the interacting partner in the sample; and (d) comparing the subject's relative expression to a standard or model, wherein a significant difference or substantial similarity between the subject's relative expression and the standard or model indicates the biological state, disease or disease stage.

In another aspect, a method for generating a network signature identifying a biological state, a disease or disease stage, comprises: (a) obtaining gene expression levels from a reference population having two or more different biological states, diseases or disease stages; (b) dividing the reference population gene expression levels into two or more groups, each group characteristic of one said different biological state, disease or disease stage; and (c) assessing differences in relative gene expression levels between hub proteins and interacting partners in the groups to identify hub proteins whose expression relative to their interacting partners is characteristic of one said different biological state, disease or disease stage.

In another aspect, a method for generating a network signature identifying a biological state, a disease or disease stage, comprises: (a) obtaining gene expression levels from a reference population having two different biological states, diseases or disease stages; (b) dividing the reference population gene expression levels into two groups, each group characteristic of a different biological state, disease or disease stage; and (c) assessing differences in relative gene expression levels between a hub protein and an interacting partner in the groups to identify a hub protein whose expression relative to an interacting partner is characteristic of a biological state, disease or disease stage.

In another aspect, a system comprises a computer processor capable of processing gene expression data for hub proteins and their interacting partners, an input device, an output device, and a memory capable of storing computer-readable instructions, wherein the contents of the memory comprises computer-readable instructions that if executed are capable of directing the computer to: (a) receive gene expression level data from a biological sample from a subject; (b) determine the relative expression of hub proteins and their interacting partners in the sample; (c) compare the relative expression to a standard or model; and (d) output an indication of the presence of a biological state, a disease or disease stage, likelihood thereof, or prognosis therefor.

In another aspect, a system comprises a computer processor capable of processing gene expression data for a hub protein and its interacting partners, an input device, an output device, and a memory capable of storing computer-readable instructions, wherein the contents of the memory comprises computer-readable instructions that if executed are capable of directing the computer to: (a) receive gene expression levels data from a biological sample from a subject; (b) determine the relative expression of a hub protein and an interacting partner in the sample; (c) compare the relative expression to a standard or model; and (d) output an indication of the presence of a biological state, a disease or disease stage, likelihood thereof, or prognosis therefor.

In another aspect, a system comprises a computer processor capable of processing gene expression data for hub proteins and their interacting partners, an input device, an output device, and a memory capable of storing computer-readable instructions, wherein the contents of the memory comprises computer-readable instructions that if executed are capable of directing the computer to: (a) receive gene expression level data from a reference population having two or more different biological states, diseases or disease stages; (b) divide reference population gene expression levels into two or more groups, each group characteristic of a different biological state, disease or disease stage; (c) determine the relative gene expression of hub proteins and their interacting partners in the groups; (d) assess differences in relative gene expression levels between hub proteins and their interacting partners in the groups to identify hub proteins whose expression relative to their interacting partners is characteristic of a biological state, disease or disease stage; and (f) output a network signature useful in identifying a biological state, disease or disease stage.

In another aspect, a system comprises a computer processor capable of processing gene expression data for a hub protein and its interacting partners, an input device, an output device, and a memory capable of storing computer-readable instructions, wherein the contents of the memory comprises computer-readable instructions that if executed are capable of directing the computer to: (a) receive gene expression level data from a reference population having two different biological states, diseases or disease stages; (b) divide reference population gene expression levels into two groups, each group characteristic of one said different biological state, disease or disease stage; (c) determine the relative gene expression of a hub protein and an interacting partner in the groups; (d) assess differences in relative gene expression levels between a hub protein and an interacting partner in the groups to identify a hub protein whose expression relative to an interacting partner is characteristic of one said different biological state, disease or disease stage; (e) repeat (c) and (d) for additional interacting partners with the hub protein, and for additional hub proteins and their interacting partners; and (f) output a network signature useful in identifying a biological state, disease or disease stage.

In another aspect, a computer-readable medium, comprises computer-readable code that if executed is configured to: (a) compare the relative expression of hub proteins and their interacting partners detected in a subject's sample to a standard or model characteristic of a biological state, disease or disease stage; and (b) provide an indication of a biological state, disease or disease stage in the subject based upon the comparison.

In another aspect, a computer-readable medium, comprises computer-readable code that if executed is configured to: (a) compare the relative expression of a hub protein and an interacting partner detected in a subject's sample to a standard or model characteristic of a biological state, disease or disease stage; and (b) provide an indication of a biological state, disease or disease stage in the subject based upon the comparison.

In another aspect, a computer-readable medium, comprising computer-readable code that if executed is configured to: (a) receive gene expression level data from a reference population having two or more different biological states, diseases or disease stages; (b) divide reference population gene expression levels into two or more groups, each group characteristic of a different biological state, disease or disease stage; (c) determine the relative gene expression of hub proteins and their interacting partner in the groups; (d) assess differences in relative gene expression levels between hub proteins and their interacting partners in the groups to identify hub proteins whose expression relative to their interacting partners is characteristic of a biological state, disease or disease stage; and (f) provide a network signature useful in identifying a biological state, disease or disease stage.

In another aspect, a computer-readable medium, comprising computer-readable code that if executed is configured to: (a) receive gene expression level data from a reference population having two different biological states, diseases or disease stages; (b) divide reference population gene expression levels into two groups, each group characteristic of one different biological state, disease or disease stage; (c) determine the relative gene expression of a hub protein and an interacting partner in the groups; (d) assess differences in relative gene expression levels between a hub protein and an interacting partner in the groups to identify a hub protein whose expression relative to an interacting partner is characteristic of one said different biological state, disease or disease stage; (e) repeat (c) and (d) for additional interacting partners with the hub protein, and for additional hub proteins and their interacting partners; and (f) provide a network signature useful in identifying a biological state, disease or disease stage.

Other objects, features and advantages of the present invention will become apparent from the following detailed description. It should be understood, however, that the detailed description and the specific examples while indicating preferred embodiments of the invention are given by way of illustration only, since various changes and modifications within the spirit and scope of the invention will become apparent to those skilled in the art from this detailed description.

### DESCRIPTION OF THE DRAWINGS

The invention will now be described in relation to the drawings in which:

FIGS. 1A through 1D provide evidence of dynamic network modularity in the human interactome. FIG. 1A is a graph in which the probability density of the average PCC of co-expression for human hub proteins with their interactors across 79 human tissues (grey line) is plotted. A multi-modal distribution is apparent for the observed data whereas a randomization of the same data yielded a unimodal distribution (dashed black line). FIG. 1B is a graph in which the probability density of the average PCC of co-expression for human hub proteins with their interactors taken solely from literature curated sources (MINT) across 79 human tissues (grey line) is shown. A bimodal distribution is apparent for the observed data whereas a randomization of the same data results in a unimodal distribution (dashed black line). FIG. 1C is a network graph of the dynamic modular nature of the human interactome. Intramodular hubs (indicated by dark line on lower left quadrant of circumference) and intermodular hubs (indicated by dark grey line on upper left quadrant) are arranged around the circumference, with interactions shown as edges that are shown in grey scale according to the PCC of co-expression of the partner proteins as shown. FIG. 1D is a graph in which the probability density of the average PCC of co-expression of human hub proteins whose interactions have been mapped from the yeast proteome to human homologues (solid grey line) with a randomization of the same data (dashed black line). A unimodal distribution with high average PCC, by definition intramodular hubs, is observed for human homologues of yeast hubs.

FIGS. 2A-2D show functional and network properties of inter and intramodular hubs. FIG. 2A is a graph which shows a subnetwork displaying the high level of correlation of co-expression of the 26S proteasome subunits across 79 human tissues. Hubs and edges are colour-coded in gray scale as in FIGS. 1A-1D. Note that three components are expressed in a tissue specific manner to modulate proteasome function. FIG. 2B is a graph which is a probability density of the semantic similarity (LinGO⁴⁵) Gene Ontology (GO) molecular function of either intermodular hubs (line with lower peak) or intramodular hubs (line with rightmost peak) is shown. Intramodular hubs have greater GO molecular function similarity with their partners than do intermodular hubs. FIG. 2C shows the average protein interaction network Betweenness as a function of equivalent intermodular hub (dark line) or intramodular (light grey line) hub removal. An equivalent number of intermodular and intramodular hubs were removed from the network in order of descending clustering coefficient resulting in a sharp loss in average network Betweenness when intermodular hubs were removed. FIG. 2D is a graph which depicts the protein interaction network characteristic path length (CPL) as a function of equivalent intermodular (dark line) or intramodular (light gray line) hub removal. The indicated hub types were removed from the network in order of descending clustering coefficient resulting in increasing CPL when both hub types were removed. However, at a critical point of intermodular hub removal the network splinters into small sub graphs and the CPL of the remaining subgraphs decreases. An equivalent trend is not observed for intramodular hub removal.

FIGS. 3A(i) through 3B show the structural and functional features of intermodular and intramodular hubs. FIG. 3A (i) is composed of two graphs that show the mean modularity (number of different domains/protein) from observed intermodular hubs or intramodular hubs versus the distribution of 10⁶ sample means of sequences taken from randomizations of the entire population of hubs. Intermodular hubs have greater modularity (P<0.02), whereas intramodular hubs have lower modularity (P<0.02) than equivalent distribution of sequences. FIG. 3A(ii) is composed of two graphs that show mean globularity (sequence length of domains) found in observed intermodular or intramodular hubs with the same randomization as FIG. 3A(i). Intermodular hubs have lower globularity (P<0.03) whereas intramodular hubs have greater modularity (P<0.002) than equivalent distribution of sequences. FIG. 3A(iii) is composed of two graphs that show the mean number of experimentally validated linear motifs and phosphosites from the ELM and Phospho-ELM database in intermodular or intramodular hubs with the same randomization as above. Intermodular hubs have more linear motifs (P<0.004), whereas intramodular hubs have less linear motifs (P<0.004) than equivalent distribution of sequences. FIG. 3B shows the domain distribution between intermodular hubs and intramodular hubs. The normalized frequency of each domain was taken as the frequency of the domain found in intermodular hubs minus the frequency found in intramodular hubs divided by total frequency of that domain. Domains involved in signalling according to the SMART database are represented by bars in the upper graph, whereas all other domains are in the lower graph. The majority of signalling domains are found in intermodular hubs whereas non-signalling domains are evenly distributed between intermodular and intramodular hubs (results of a binomial sign test are shown; p<0.001).

FIGS. 4A-4C show evidence of dynamic network modularity in signalling networks and cancer phenotypes. FIG. 4A is a subnetwork focused on the intermodular and intramodular hubs that mediate RAS signalling. Interactions between intramodular hubs (shown as dark gray circles in the top and bottom of the figure) and intermodular hubs (shown as four lighter grey circles in the top cluster and those in the middle cluster of circles of the figure) are depicted. Edges (dark gray) reflecting interactions between RAS hub (top cluster) components and a cluster of intermodular hubs (middle cluster) that in turn link (light gray edges) to a downstream cluster of intramodular hubs. Edges within each of these three clusters are in black and some select nodes are identified. Note that RAS only connects with the downstream intramodular cluster via intermodular hubs. FIG. 4B is a graph which shows that frequency of inter and intramodular hubs in OMIM entries associated with cancer, relative to all OMIM entries was calculated. Intermodular hubs are enriched in OMIM entries associated with cancer (Fisher's exact test, P<0.05). FIG. 4C is a graph which shows an analysis of association of hub type with translocation fusion entries in OMIM and reveals that intermodular hubs are enriched in oncogenic translocation fusions relative to all OMIM entries for intermodular or intramodular hubs (Fisher's exact test, P<0.01).

FIGS. 5A and 5B show the differences in dynamic network properties in breast cancer tumours. FIG. 5A shows a focused network of a hub that is significantly changed between patients who survive after follow up and those that die from disease. BRCA1 and its interactors (in particular BRCA2 and MRE11) are highly ordered in the surviving patients whereas that organization is lost in patients who die of disease. Conversely, Sp1 is not significantly changed between alive and dead patients as the organization of the hub and its interactors remains largely the same. FIG. 5B shows all hubs whose correlation of coexpression with their partners was significantly changed as a function of patient outcome are shown as darker grey lines or nodes. Direct interactions between hubs are shown with black edges. Note that most hubs are components of a highly interconnected network. The network includes many functional groups known to be misregulated in breast cancer pathogenesis, highlighted as indicated in the legend. Inset is the detailed interaction subnetwork of the SRC oncogene, with the significant expression of nodes shown with node colour according to the legend (bottom). The difference in PCC for each interaction between patients who live and patients who died of disease is shown as edge colour according to the top legend. SRC is not significantly differentially expressed between patient groups but is a significant predictor hub in the analysis because of differences in the co-ordination of co-expression amongst SRC and many of its partners.

FIGS. 6A-6D show the differences in dynamic network properties predicts breast cancer outcome. FIG. 6A is a ROC curve of the probabilities for prognostic group membership from the clustering of patient dynamic network properties summarized for all 5-fold cross validation runs. The true and false positive rate is plotted for each division of the groups based on network probabilities alone (darkest curved line) or the network properties of each tumour whilst controlling for TNM tumour classifications (grey leftmost line of graph) and a random division of patients (black diagonal line). FIG. 6B shows Kaplan-Meier disease-free survival curves of the good and poor prognostic groups obtained from the 5-fold cross validation of the network probabilities alone (two lowest interwoven lines) or of the network probabilities controlled for clinical covariates (two uppermost lines on graph). The poor prognosis group has a significant increased risk of death from disease compared with the good prognosis group. FIG. 6C is a graph showing the average ratio of the number of publications for included and excluded hubs in the breast cancer literature relative to the total number of publications for those genes. Significant hubs are much more frequently cited in the breast cancer literature (p<0.001). FIG. 6D is a graph showing that breast cancer patient prognostic predictive value is related to the total size of the protein interaction network. Interactions were randomly removed to obtain interactomes of reduced size, as indicated. The accuracy of prediction of outcome using dynamic network modularity at each indicated interactome size was then assessed by ROC curve analysis and is plotted as the average AUC (±SD) of three runs of 5-fold cross-validation. Note that performance declines as a function of decreasing interactome size.

FIG. 7 is a graph showing that the probability density of the average PCC of co-expression for human hub proteins with their interactors taken solely from another high confidence PPi database (STRING) across 79 human tissues (solid line). A multimodal distribution is apparent for the observed data whereas a randomization of the same data resulted in a unimodal distribution (dashed black line).

FIGS. 8A-8F show the biochemical features of intermodular and intramodular hubs. FIG. 8A is a graph showing mean amino acid length of intermodular hubs. FIG. 8B is a graph showing mean amino acid length of intramodular hubs. Intermodular hubs have a greater mean amino acid length then intramodular hubs. FIG. 8C is a graph showing the mean number of PO₄ sites from the ELM and Phospho.ELM database from observed intermodular hubs versus the distribution 10,000 sample means of random sequences with the same length distribution of either the intermodular or intramodular hub population. FIG. 8D is a graph showing the mean number of linear motifs from the ELM and Phospho.ELM database from observed intermodular hubs versus the distribution 10,000 sample means of random sequences with the same length distribution of either the intermodular or intramodular hub population. FIG. 8E is a graph showing the mean number of PO₄ sites from the ELM and Phospho.ELM database from observed intramodular hubs versus the distribution 10,000 sample means of random sequences with the same length distribution of either the intermodular or intramodular hub population. FIG. 8F is a graph showing the mean number of linear motifs from the ELM and Phospho.ELM database from observed intramodular hubs versus the distribution 10,000 sample means of random sequences with the same length distribution of either the intermodular or intramodular hub population. The observed number phospho-sites/1000 amino acids and the observed number of linear motifs/hub is greater than expected in intermodular hubs (P<0.005 and P<0.002, respectively), whereas intramodular hubs have fewer phospho-sites/1000 amino acids and fewer linear motifs/hub than expected (P<0.04 and P<0.001, respectively).

FIG. 9A is a bar graph showing the frequency of oncogenic mutations in intermodular or intramodular hubs. Dominant oncogenic mutations are more frequently found in intermodular hubs than intramodular hubs relative to the frequency of intermodular hubs or intramodular hubs (Fisher's exact test, P<0.05). FIG. 9B is a bar graph showing that the frequency of intermodular-intermodular and intermodular-intramodular fusions found to result in oncogenic transformation are approximately twice that of intramodular-intramodular oncogenic translocation fusions.

FIG. 10 is a graph showing the probability density of inter and intramodular hubs over the range of degree for the hubs. There is no significant difference in the distribution of degree between the 2 classes of hubs, suggesting that the observed differences in biological features between the two hub types is not a function of degree distribution of the two hub classes.

FIG. 11 is a bar graph showing the expected and observed ratios of significant predictors in the data provided herein (including interactors of hubs) and predictors in previous genomic studies of breast cancer diagnosis. The overlap between the significant predictors herein and predictors from previous studies is greater than expected (P<0.02).

FIG. 12A is a ROC curve of the probabilities for prognostic group membership from the clustering of patient dynamic network properties summarized for all 5-fold cross validation runs with an independent sample of breast cancer patients³³. The true and false positive rate is plotted for each division of the groups based on network probabilities alone (middle curve) or the network properties of each tumour whilst controlling for TNM tumour classifications (top line) and a random division of patients (black diagonal line). FIG. 12B is a graph showing Kaplan-Meier disease-free survival curves of the good and poor prognostic groups obtained from the 5-fold cross validation in an independent cohort³³ of breast cancer patients of the network probabilities controlled for clinical covariates. The poor prognosis group (lower line on graph) has a significant increased risk of death from disease compared with the good prognosis group (top line).

FIGS. 13A and 13B show the optimization and validation of adjustable parameters for patient prediction algorithm. FIG. 13A is a series of graphs showing Area under the ROC curve (AUC, a measure of algorithm accuracy) measured for 5-fold cross validation runs of the feature selection (significant hub) and clustering of patients with significant hubs based on their hubs dynamic network behaviour. Degree (k) and p-value cut-off of significant hubs was concomitantly adjusted to determine an optimal k and p-values to determine significant hub predictors to run the clustering algorithm. A strong peak in AUC was observed for P≦0.09 and degree of greater than 2. FIG. 13B is a graph of AUC and the standard error of AUC measured for 3 runs of 5-fold cross validation of the clustering algorithm after filtering significant hubs with degree greater than 2 for degree greater than 3 and up to 50. One curve using the real interactome and setting a p-value cut-off less than 0.09 and one using a randomized interactome. For degree filters up to k>9 the real interactome and significant hubs (P≦0.09) the accuracy of the algorithm is significantly greater than the random interactome or the non-significant hubs.

### DETAILED DESCRIPTION OF THE INVENTION

Unless defined otherwise, all technical and scientific terms used herein have the same meaning as commonly understood by one of ordinary skill in the art to which this invention belongs. The following definitions supplement those in the art and are directed to the present application and are not to be imputed to any related or unrelated case. Although any methods and materials similar or equivalent to those described herein can be used in the practice of the invention, particular materials and methods are described herein.

Numerical ranges recited herein by endpoints include all numbers and fractions subsumed within that range (e.g., 1 to 5 includes 1, 1.5, 2, 2.75, 3, 3.90, 4, and 5). In another embodiment, all fractions or integers between and including the two numbers are included in the range. It is also to be understood that all numbers and fractions thereof are presumed to be modified by the term “about.” The term “about” means plus or minus 0.1 to 50%, 5-50%, or 10-40%, preferably 10-20%, more preferably 10% or 15%, of the number to which reference is being made. As used herein and in the appended claims, the singular forms “a”, “an”, and “the” include plural reference unless the context clearly dictates otherwise. Thus, for example, reference to an “interacting partner” is a reference to one or more interacting partners and equivalents thereof known to those skilled in the art, and so forth. Further, various embodiments in the specification or claims are presented using “comprising” language. In certain embodiments, a related embodiment may also be described using “consisting of” or “consisting essentially of” language.

“Biological state” includes without limitation a healthy state, a disease state, a potential disease state, a stage of a disease, prognosis of a disease, a physiological state, drug responsive or drug non-responsive state, toxicity of one or more drugs, toxicity state, biological state of an organ, presence of a pathogen (e.g. a virus), and the like.

A “reference data set” generally comprises quantitative data for putative informative hubs and interacting partners for a reference population and data characterizing different class distinctions (e.g. biological states, in particular disease states) in the reference population. Reference data sets can be from published data, clinical or test data or from samples from a reference population. One skilled in the art can readily determine an appropriate reference population based on particular applications of methods of the invention. A reference data set generally includes data relating to two or more different class distinctions. In aspects of the invention, a reference data set includes data concerning two or more different health states of a reference population (e.g. healthy state versus disease state). Reference populations can be selected on a variety of criteria based on the particular application of methods of the invention. Examples of criteria include health state, disease state, age, gender, drug use, genetic similarity, ethnicity, or other criteria. A reference population can be focused on a particular criteria or contain a variety of individuals having more than one state. The number of individuals to be included in a reference population to obtain a statistically useful determination can be readily determined by one skilled in the art. A reference population may generally contain tens, hundreds, or thousands of reference individuals or samples depending on the particular application.

A “network signature” refers to the level or amount of co-expression of one or more hubs and their interacting partners in a given population or sample at one or more time points. A “reference” network signature is a profile of a particular set of hubs (e.g. informative hubs) and their interacting partners that is characteristic of a particular class (e.g. biological state). For example, a reference network signature that quantitatively describes the expression of hubs and their interacting partners in breast cancer (see Example 1) can be used for determining prognosis in individual breast cancer patients. Reference network signatures may be generated using a reference data set. In certain embodiments, a network signature includes a complete network or subnetworks, i.e., a skeleton network. In one embodiment, a network signature includes a profile of all hubs identified using the algorithms or code contained herein. A skeleton network is a spanning tree (i.e., a tree composed of n−1 edges that connects all n vertices in the network) formed by the edges with the highest betweenness centralities. The remaining edges in the network are shortcuts. A skeleton network can be identified using published methods⁴⁸.

In an embodiment, network signatures are comprised of 2, 3, 4, 5, 10, 15, 20, 25, 50, or more hubs or hub/interacting partner sets. The informative hubs and interacting partners that are used in network signatures can be hubs and interacting partners that exhibit increased expression over normal samples or decreased expression versus normal samples. The particular set of informative hubs and interacting partners used to create a network signature can be, for example, the hubs and interacting partners that exhibit the greatest degree of differential co-expression, or they can be any set of informative hubs and interacting partners that exhibit some degree of differential co-expression and provide sufficient power to accurately classify a sample. The hubs and interacting partners selected are those that have been determined to be differentially expressed in for example a disease, different disease state, drug-responsiveness, or drug-sensitive sample, relative to a normal sample or different disease state or drug-responsiveness and confer power to classify the sample. By comparing samples from patients with reference network signatures, the patient's susceptibility to a particular disease, prognosis, disease state, drug-responsiveness, or drug-resistance can be determined. In another embodiment a subset of a network signature includes only a portion of the network signature minimally necessary to distinguish the biological state, disease or disease stage thereof.

In yet another embodiment, a network signature is formed by the relative expression or pattern of relative expression of at least one, and preferably more than one, hub protein and one, or preferably more than one, of each hub's interacting partner proteins, which relative expression or pattern is characteristic of a disease, i.e., is changed from the relative expression of the hub/interacting partners in the healthy, non-disease state. In one embodiment, the network signature is formed by the relative expression of at least 5 hub protein/interacting partner protein sets. In one embodiment, the network signature is formed by the relative expression of at least 10, at least 20, at least 40, at least 50, at least 70, at least 100, at least 200, at least 300 or at least 500 or more hub protein/interacting partner protein sets. The network signature can take many forms, e.g., it can be identified as a number, a series of numbers, or graphs, e.g., bar graphs or curves.

A “reference” or “standard” or “model” thus refers to a network signature or a subset of a network signature that characterizes a particular biological state. As used herein, for example, a reference or standard or model may in one embodiment be a network signature characteristic of a healthy, disease-free state in a reference population. In another embodiment, the reference” or “standard” or “model” is a network signature characteristic of the presence of a particular disease at a designated stage of disease, e.g., stage I cancers, in a reference population. In another embodiment, the reference” or “standard” or “model” is a network signature characteristic of a reference population having a disease that had a poor outcome. In another embodiment, the reference” or “standard” or “model” is a network signature characteristic of a reference population having a disease that had a good outcome, e.g., survival for a selected number of years post-diagnosis. In yet another embodiment, the reference, standard or model may be a network signature formed of disease-characteristic hubs/interacting partners from a single subject at a particular time. These latter references are particularly useful in assessing progression of the disease or monitoring efficacy of therapeutic intervention. For example, the single reference subject may be the same subject being monitored for disease progression or therapeutic efficacy.

The generation of a network signature requires a method for assaying or quantitating the expression of hubs and interacting partners in samples. The expression levels of genes encoding the hubs and interacting partners or gene products, e.g., proteins, may be assayed in samples. Methods are currently available to one of skill in the art to quickly determine the expression level of several gene products from samples. Hybridization assays can be used to rapidly determine expression of gene products in samples. Microarrays or gene chips comprising short oligonucleotides complementary to mRNA products chemically attached to a solid support can be used for a rapid determination of gene expression in samples. Microarrays are commercially available, for example from Affymetrix, Santa Clara, Calif. Alternatively, methods are known to one skilled in the art for a variety of immunoassays to detect protein expression products. Some aspects of the invention may use spectrometric data of components of the hubs and interacting partners obtained from any spectrometric or chromatographic technique including without limitation resonance spectroscopy, mass spectroscopy, and optical spectroscopy. Examples of spectrometric platforms include MS, NMR, liquid chromatography, gas chromatography, high performance liquid chromatography, capillary electrophoresis, and any known form of mass spectrometry in low or high resolution mode such as LC-MS, GC-MS, CE-MS, LC-UV, MS-MS, MSⁿ, etc. The methods described herein are not limited by the particular process selected to detect or quantify expression levels of the genes or gene products, including the hubs and their interacting partners. One of skill in the art may readily select a suitable conventional method for same.

The term “relative expression” as used herein refers to the interrelationship of the expression of one or more hubs with the expression of each of their interacting partners. Relative expression is generally the hub expression level minus interactor expression level. The relative expression may be a numerical or graphical representation of the interrelationship or pattern created by correlating the expression level of a hub protein with the expression level of one or preferably more of its interacting partner(s) in one or more samples. The correlation of these expression levels relative to each other in the hub/interacting partner complexes can cause a change in the network signature characteristic of a particular biological state, disease or disease stage.

“Correlation analysis” refers to a correlation-based similarity analysis including a correlation analysis using Pearson's correlation coefficient (PCC) including the related Spearman's rho and Kendall's tau known in the art.

“Disease” refers to any disorder, disease, condition, syndrome or combination of manifestations or symptoms recognized or diagnosed as a disorder which may be correlated with or characterized by co-expression of a subset of hubs and their interacting proteins in an interactome. The invention has application in any disease in which changes in the patterns of informative hubs and their interacting proteins allow it to be distinguished from a non-diseased state. Therefore, diseases that have a genetic component in which the genetic abnormality is expressed, diseases in which the expression of drug toxicity is observed, or diseases in which the levels of molecules in the body are affected may be studied by the present invention.

Exemplary diseases include, for example, cancer, cardiovascular diseases including heart failure, hypertension and atherosclerosis, respiratory diseases, renal diseases, gastrointestinal diseases including inflammatory bowel diseases such as Crohn's disease and ulcerative colitis, hepatic, gallbladder and bile duct diseases, including hepatitis and cirrhosis, hematologic diseases, metabolic diseases, endocrine and reproductive diseases, including diabetes, bone and bone mineral metabolism diseases, immune system diseases including autoimmune diseases such as rheumatoid arthritis, lupus erythematosus, and other autoimmune diseases, musculoskeletal and connective tissue diseases, including arthritis, infectious diseases and neurological diseases such as Alzheimer's disease, Huntington's disease and Parkinson's disease.

Although the invention is generic, embodiments of the invention provide for diagnosis or prognosis of various cancers including but not limited to carcinomas, melanomas, lymphomas, sarcomas, blastomas, leukemias, myelomas, osteosarcomas, neural tumors, and cancer of organs such as the breast, ovary, and prostate. A particular embodiment of the invention relates to the discovery and use of relative expression, or co-expression patterns, of hubs and interacting partners that reflect the current or future biological state of an organ or tissue.

“Hub” refers to a protein that interacts with two or more interacting partners, preferably 3, 4, 5, 6, 7, 8, 9, or 10 or more interacting partners. A significant or informative hub is a hub that significantly discriminates between classes, in particular biological states, more particularly disease states. In aspects of the invention, the hubs are intermodular hubs. In an embodiment, an informative or significant hub displays significantly altered PCC as a function of disease state, in particular disease outcome. In an embodiment, the informative or significant hubs display significantly altered PCC as a function of breast cancer disease outcome. Examples of such breast cancer outcome informative hubs include without limitation one or more of the BASC complex, MAP3K1, GRB2, SHC and SRC, estrogen signaling (ESR1), the DNA damage response (BRCA1, RAD51, MRE11), proteasome components and ribosomal components.

“Interactome” refers to sets of molecular interactions in cells, in particular protein-protein interaction networks.

“Intermodular hubs” refers to classes of hubs in the human interactome that display low correlation of co-expression with their partners. Intermodular hubs may generally be characterized by one or more of the following: (a) less molecular functional similarity with their interactors compared to intramodular hubs; (b) interact between functional modules; (c) important for global network connectivity; (d) greater average sequence length than intramodular hubs; (e) higher modularity compared to intramodular hubs; (0 lower globularity than intramodular hubs; (g) linear motifs are significantly over-represented compared with intramodular hubs; and (h) enriched in domains associated with cell signaling, in particular tyrosine kinase, PDZ and Gα domains.

“Intramodular hubs” refers to classes of hubs in the human interactome that display relatively higher correlation of co-expression compared with intermodular hubs. Intramodular hubs may generally be characterized by one or more of the following: (a) greater molecular functional similarity with their interactors compared to intermodular hubs; (b) act as key components within more functionally homogenous modules; (c) lower average sequence length than intermodular hubs; (d) greater globularity than intermodular hubs; and (e) linear motifs are significantly under-represented compared with intermodular hubs.

“Pearson Correlation Coefficient” or “PCC” refers to the measure of the correlation between two variables and in particular reflects the degree of linear relationship between the two variables. The PCC is typically denoted by r. In the context of the present invention, the variables include the expression data for a hub and its interactors, and the PCC of each interaction of a hub may be determined as follows:

Let X_{I}_{ⱼ}=expression data of interactor I of hub H for tissue j=1, 2, 3 . . . n
Let X_{H}_{ⱼ}=expression data for hub H for tissue j=1, 2, 3 . . . n

$${r}_{I , H} = \frac{{\sum }_{j = 1}^{n} ( {X}_{{I}_{j}} - {\overline{X}}_{I} ) ( {X}_{{H}_{j}} - {\overline{X}}_{H} )}{( n - 1 ) {s}_{I} {s}_{H}}$$

$$where {\overline{X}}_{I} = \frac{{\sum }_{j = 1}^{n} {X}_{{I}_{j}}}{n}$$

$$and {\overline{X}}_{H} = \frac{{\sum }_{j = 1}^{n} {X}_{{H}_{j}}}{n}$$

$$and {S}_{I} = \sqrt{\frac{{\sum }_{j = 1}^{n} ( {X}_{{I}_{j}} - {\overline{X}}_{I} )}{( n - 1 )}}$$

$$and {S}_{H} = \sqrt{\frac{{\sum }_{j = 1}^{n} ( {X}_{{H}_{j}} - {\overline{X}}_{H} )}{( n - 1 )}}$$

where I is a interactor of hub H and j denotes the expression data for the hub or interactor in each of n tissues, and the summation is over all tissues (j=1, 2, 3 . . . n). s_{I}s_{H} is the product of the standard deviations of the expression data for the hub and interactor.

In respect to analytical methods of the invention to identify informative hubs the PCC may be defined as follows:

$${r}_{A , D} = ( \frac{\sum ( {I}_{A} - \overline{I} ) ( {H}_{A} - \overline{H} )}{( {n}_{A} - 1 ) {s}_{{I}_{A}} {s}_{{H}_{A}}} ) - ( \frac{\sum ( {I}_{D} - \overline{I} ) ( {H}_{D} - \overline{H} )}{( {n}_{D} - 1 ) {s}_{{I}_{D}} {s}_{{H}_{D}}} )$$

where I and H denote the expression of an interactor and a hub, respectively and A is a first class (e.g. biological state) and D is a second class (e.g. biological state). The summations are over the number of samples/individuals in each group and s_{IA}s_{HA} and s_{ID}s_{HD} are the products of the standard deviations of the hub and the interactor expression for the first biological state and second biological state respectively.

The term “sample” and the like mean a material known or suspected of expressing or containing one or more hubs and interacting partners. A sample can be used directly as obtained from the source or following a pretreatment to modify the character of the sample. In aspects of the invention, a sample is representative of the expression levels of informative hubs and interacting partners. A “biological sample” is a sample derived from any biological source, such as tissues, extracts, or cell cultures, including cells (e.g. tumor cells), cell lysates, and physiological fluids, such as, for example, blood or subpopulations thereof (e.g. white blood cells, erythrocytes), plasma, serum, saliva, ocular lens fluid, cerebrospinal fluid, sweat, urine, fecal matter, tears, bronchial lavage, swabbings, milk, ascites fluid, nipple aspirate, needle aspirate, synovial fluid, peritoneal fluid, lavage fluid, and the like. The sample can be obtained from animals, preferably mammals, most preferably humans. Samples can be from a single individual or pooled prior to analysis. The sample can be treated prior to use, such as preparing plasma from blood, diluting viscous fluids, and the like. Methods of treatment can involve filtration, distillation, extraction, concentration, inactivation of interfering components, the addition of reagents, and the like.

In embodiments of methods of the invention, the sample is a mammalian tissue sample. In another embodiment the sample is a human physiological fluid. In a particular embodiment, the sample is human serum. In a further embodiment, the sample is white blood cells or erythrocytes.

The samples that may be analyzed in accordance with the invention include polynucleotides, for example from clinically relevant sources, preferably expressed RNA or a nucleic acid derived therefrom (cDNA or amplified RNA derived from cDNA that incorporates an RNA polymerase promoter). The target polynucleotides can comprise RNA, including, without limitation total cellular RNA, poly(A)⁺messenger RNA (mRNA) or fraction thereof, cytoplasmic mRNA, or RNA transcribed from cDNA (i.e., cRNA; see, for example, Linsley & Schelter, or U.S. Pat. Nos. 5,545,522, 5,891,636, 5,716,785 or 6,271,002). Methods for preparing total and poly(A)⁺RNA are well known in the art, and are described generally, for example, in Sambrook et al., (1989, Molecular Cloning—A Laboratory Manual (2^{nd} Ed.), Vols. 1-3, Cold Spring Harbor Laboratory, Cold Spring Harbor, N.Y.) and Ausubel et al, eds. (1994, Current Protocols in Molecular Biology, vol. 2, Current Protocols Publishing, New York). RNA may be isolated from eukaryotic cells by procedures involving lysis of the cells and denaturation of the proteins contained in the cells. Additional steps may be utilized to remove DNA. Cell lysis may be achieved with a nonionic detergent, followed by microcentrifugation to remove the nuclei and hence the bulk of the cellular DNA. (See Chirgwin et al., 1979, Biochem. 18:5294-5299). Poly(A)+RNA can be selected using oligo-dT cellulose (see Sambrook et al., 1989, Molecular Cloning—A Laboratory Manual (2nd Ed), Vols. 1-3, Cold Spring Harbor Laboratory, Cold Spring Harbor, N.Y.). In the alternative, RNA can be separated from DNA by organic extraction, for example, with hot phenol or phenol/chloroform/isoamyl alcohol.

It may be desirable to enrich mRNA with respect to other cellular RNAs, such as transfer RNA (tRNA) and ribosomal RNA (rRNA). Most mRNAs contain a poly(A) tail at their 3′ end allowing them to be enriched by affinity chromatography, for example, using oligo(dT) or poly(U) coupled to a solid support, such as cellulose or Sephadex™ (see Ausubel et al., eds., 1994, Current Protocols in Molecular Biology, vol. 2, Current Protocols Publishing, New York). Bound poly(A)+mRNA is eluted from the affinity column using 2 mM EDTA/0.1% SDS.

The terms “subject”, “individual” or “patient” refer, interchangeably, to a warm-blooded animal such as a mammal. In particular, the terms refer to a human. A subject, individual or patient may be afflicted with or suspected of having or being pre-disposed to a disease as described herein. The term also includes animals bred for food, as pets, or for study including horses, cows, sheep, poultry, fish, pigs, cats, dogs, and zoo animals goats, apes (e.g. gorilla or chimpanzee), and rodents such as rats and mice.

The present invention relates to a method of identifying hubs that significantly correlate with a class distinction between samples. A method of the invention may involve sorting hubs and their interacting partners or interactors by degree to which their presence or co-expression in the samples correlate with the class distinction, and determining whether the correlation is stronger than expected by chance. A hub whose expression correlates with a class distinction more strongly than expected by chance is an informative hub. The class distinction can be a known class and in an embodiment the class distinction is a biological state, in particular a disease state. A known class can also be a set of subjects, in particular subjects with a favourable prognosis or subjects with an unfavourable prognosis. Conventional correlation analyses can be used to sort hubs and interacting partners. In aspects of the invention, each hub is assessed for the difference in Pearson correlation coefficient and an average co-expression of each interaction for a hub can be calculated, i.e., an estimate of the difference in correlation of each interaction around a hub between groups or samples is calculated.

Methods of the invention, for the purpose of determining the state of a sample or subject based upon hubs and their interacting partners or interactors or network signatures for the sample and for one or more reference populations, can include linear, non-linear, and/or multivariate calculations from fields including mathematics, statistics and/or computer science. Such calculations may proceed in two phases: (a) an overall computation involving training and/or estimation using data from the reference population(s), and (b) a simpler computation for an individual using the results of phase (a). The end result of such calculations is to provide one or more qualitative or quantitative indicators of the class or state of a sample or subject. Examples of calculations which may be used in the methods of the present invention include discriminant analysis, classification analysis, multiple discriminant analysis, cluster analysis, and affinity propagation analysis.

In an aspect, the invention relates to a method of identifying hubs and their interacting partners that significantly discriminate among biological states, in particular disease states and such methods may comprise obtaining a reference data set that can be clustered into different biological states and into interactions comprising hubs and their interacting partners characteristic of each biological state; and, assessing differences in interactions for each biological state to identify informative hubs that significantly discriminate between the biological states; and optionally confirming informative hubs by searching for such hubs in databases of scientific literature for the biological states.

In an aspect, the invention relates to a method of identifying hubs that discriminate between biological states, in particular disease states, comprising: (a) obtaining a reference data set that can be clustered into different biological states and which comprises expression data for genes encoding putative hubs and their interacting partners; (b) clustering the identified hubs and interacting partners by biological states and assessing differences in each interaction between a hub and interacting partners between biological states to identify informative hubs that significantly discriminate between the biological states; and optionally; (c) confirming the informative hubs by searching for the hubs in databases of scientific literature for the biological states. The clustering analysis in a method of the invention may be carried out using an affinity propagation algorithm (see Example 1).

Databases of scientific literature which can be searched in methods of the invention include without limitation PubMed and other databases available through the National Center for Biotechnology Information.

In an aspect, the invention provides a method for determining a biological state through the discovery and analysis of discriminatory data patterns or network signature of co-expression of hubs and their interacting partners. The data can be from health data, clinical data or from a biological sample. Analytical methods are utilized to discover hidden discriminatory patterns or a network signature of co-expression of hubs and their interacting partners that are a subset of a larger data set and that classify a biological state. The methods of the invention may be used to distinguish two or more biological states in a reference data set and the resulting discriminatory patterns or reference network signatures may be used to classify unknown or test samples.

In an aspect the invention provides a method for generating reference network signatures characteristic of biological states or comprising hubs and their interacting partners that discriminate between biological states, comprising: (a) obtaining a reference data set that can be clustered into different biological states and which comprises expression data for hubs and their interacting partners; (b) clustering the identified hubs and interacting partners by biological states and assessing differences in each interaction between a hub and interacting partners between biological states to identify informative hubs and their interacting partners that significantly discriminate between the biological states; and (c) obtaining reference network signatures of the co-expression of informative hubs and interacting partners characteristic of the biological states or comprising hubs and their interacting partners that discriminate between biological states.

Methods of the invention for generating a network signature may further comprise preparing a subnetwork signature, in particular a skeleton network signature.

The invention provides sets of informative hubs and interactors and network signatures that distinguish classes, in particular biological states, more particularly disease states, and uses therefor. The invention also provides microarrays comprising genes encoding informative hubs and their interacting partners. The invention further provides computer-readable data media or databases comprising informative hubs and interactors and network signatures that distinguish classes.

The invention also provides a method for distinguishing a class, in particular a biological state, more particularly a disease state, in a sample by determining differences in co-expression of informative hubs and their interactors or network signatures in a sample from the subject compared with a standard or model.

In aspects of the invention, methods are provided for detecting the presence of a disease (e.g. cancer) in a sample, the absence of a disease in a sample, the stage of a disease, the stage or grade of the disease, and other characteristics of diseases that are relevant to prevention, diagnosis, characterization, and therapy in a patient, for example, the benign or malignant nature of a cancer, the metastatic potential of a cancer, the indolence or aggressiveness of a cancer, and other characteristics of diseases that are relevant to prevention, diagnosis, characterization, and therapy of diseases or drug responsiveness in a patient. Methods are also provided for assessing the efficacy or responsiveness of a therapy for a disease, monitoring the progression of a disease, determining the prognosis of a patient, selecting an agent or therapy for treating or inhibiting a disease, treating a patient afflicted with a disease, inhibiting a disease in a patient, and assessing the disease (e.g. carcinogenic) potential of a test compound.

In an aspect, the invention relates to a method of characterizing or classifying a sample from a patient (e.g. a biological sample), by detecting or quantitating in the sample amounts or levels of informative hubs and their interactors that are characteristic of the disease, the method comprising assaying for differential co-expression of the hubs and their interactors in the sample. The expression levels of hubs and interacting partners may be determined by isolating and determining the level of transcribed nucleic acids. Alternatively or additionally, the levels of co-expression of the polypeptides may be determined. Co-expression of the hubs and their interactors can be assayed using techniques known in the art, such as microarrays or mass spectroscopy of the components of the hubs and interacting partners or genes encoding same extracted from the sample.

The invention pertains to a method for classifying a sample obtained from an individual into a class (e.g. favorable or poor prognosis) comprising assessing the sample for co-expression of informative hubs and their interacting partners and classifying the sample as a function of expression of informative hubs and interacting partners with respect to a model.

In an aspect, the invention provides a method for characterizing or classifying a disease state in a subject comprising: (a) obtaining a sample from a subject; (b) producing a sample network signature of informative hubs and their interactors in the sample; and (c) comparing the sample network signature with a reference network signature to characterize the disease state in the subject.

In an aspect, a method is provided for characterizing a disease sample by detecting co-expression of informative hubs and interacting partners in the sample comprising: (a) (a) obtaining a sample from a subject; (b) measuring levels of co-expression of informative hubs and interacting partners in the sample; and (c) comparing the levels with amounts measured for a standard or model.

In an embodiment of the invention, a method is provided for detecting breast cancer in a subject comprising: (a) obtaining a sample from the subject; (b) measuring levels of co-expression of hubs and their interacting partners characteristic of breast cancer in the sample; and (c) comparing the levels with levels detected for a standard or model.

In an embodiment, the invention relates to classifying a breast cancer patient according to prognosis comprising: (a) comparing the levels of co-expression of hubs and interacting partners characteristic of breast cancer in a sample from the patient to levels of co-expression of the hubs and interacting partners in a reference population; and (b) classifying the patient according to prognosis of the breast cancer based on the similarity between the levels of co-expression in the sample and the reference population. In a specific embodiment, step (b) comprises determining whether the similarity exceeds one or more predetermined threshold values of similarity.

In a further embodiment, the methods further comprise assigning a therapeutic regimen to the diagnosed subject, e.g., a breast cancer patient. In an embodiment, the invention provides a method for assigning a therapeutic regimen to a patient comprising classifying the patient as having a poor prognosis or good prognosis on the basis of co-expression of informative hubs and interacting partners and assigning the patient a therapeutic regimen comprising no adjuvant chemotherapy if the patient is classified as having a good prognosis or comprising chemotherapy if the patient has a poor prognosis.

In embodiments of the methods of the invention for breast cancer diagnosis or prognosis, the hubs are informative hubs, in particular one or more informative hubs chosen from or selected from the group consisting of the BASC complex, MAP3K1, GRB2, SHC and SRC, estrogen signaling (ESR1), the DNA damage response (BRCA1, RAD51, MRE11), proteasome components and ribosomal components.

Still another embodiment of a method for diagnosing a subject for the presence of a biological state, a disease or disease stage comprises: (a) obtaining a biological sample from the subject; (b) detecting the expression levels of a hub protein and interacting partner(s) in the sample; (c) determining the relative expression of a hub protein and interacting partner(s) in the sample; (d) comparing the subject's relative expression to a standard or model. Such a standard or model, in one embodiment, is a network signature characteristic of a biological state, a disease or disease stage in a reference population. In one embodiment, the relative expression is determined for each significant hub in each subject, as described in Example 1. In one embodiment the algorithm to measure the difference in co-expression of the hubs and each interacting protein of those hubs found to be significant uses the following equation:

InteractionDiff=Iₙ−H

where the difference is taken of the expression of each of n interactors, Iₙ, from each significant hub, H, and all significant hubs are evaluated. Patient data are then clustered using the affinity propagation⁴⁴ algorithm. In another embodiment, the standard or model is a subject-specific network signature of the same subject generated from a temporally earlier biological sample. In aspects, a significant difference between the subject's relative expression and the standard or model indicates a biological state, disease or disease stage, or can identify whether therapeutic intervention is necessary or, if currently administered, is efficacious. In other aspects, a significant similarity between the subject's relative expression and the standard or model indicates a biological state, disease or disease stage, or can identify whether therapeutic intervention is necessary or, if currently administered, is efficacious. In such a method, one may repeat step (c) for additional interacting partners with the hub protein, and for additional hub proteins and their interacting partners, to generate a subject-specific network signature useful in identifying the biological state, disease or disease stage. In still another embodiment, the steps (b), (c) and/or (d) may transform the expression levels of a hub protein and an interacting partner, or relative expression, into numerical or graphical form. This may be done by a suitably programmed computer or processor. For example, see the code in Example 3. In another embodiment, this method can assist in predicting likelihood of recurrence of a disease, depending upon the selection of the standard or model.

In another embodiment, a method for generating a network signature identifying a biological state, a disease or disease stage is performed by (a) obtaining gene expression levels from a reference population having at least two different biological states, diseases or disease stages; (b) dividing the reference population gene expression levels into groups, each group characteristic of one different biological state, disease or disease stage; and (c) assessing differences in relative gene expression levels between a hub protein and an interacting partner in the groups to identify a hub protein whose expression relative to an interacting partner is characteristic of one said different biological state, disease or disease stage. In one embodiment, the method includes centering of the expression levels of (a) and/or (b). In one embodiment, the centering may be median centering. In certain embodiments of this method, step (c) is repeated for additional interacting partners with the hub protein, and for additional hub proteins and their interacting partners, to generate a network signature useful in identifying a biological state, disease or disease stage. In still other embodiments of this method, step (c) includes (i) matching each expression level to a hub protein or an interacting partner protein of the hub protein; (ii) obtaining the Pearson correlation coefficient (r) for each hub protein using the following equation:

$${r}_{A , D} = ( \frac{\sum ( {I}_{A} - \overline{I} ) ( {H}_{A} - \overline{H} )}{( {n}_{A} - 1 ) {s}_{{I}_{A}} {s}_{{H}_{A}}} ) - ( \frac{\sum ( {I}_{D} - \overline{I} ) ( {H}_{D} - \overline{H} )}{( {n}_{D} - 1 ) {s}_{{I}_{D}} {s}_{{H}_{D}}} )$$

wherein:
“I” denotes the amount of expression of an interacting partner,
“H” denotes the amount of expression of a hub protein,
“A” denotes the group of subjects having one biological state, disease or disease stage,
“D” denotes the group of subjects having a different biological state, disease or disease stage,
“n_{A} or n_{D}” denotes the number of subjects in each group, and
“^{S}1_{A} and ^{S}1_{D}” are the products of the standard deviations of the hub protein and the interacting partner expression for the respective groups; and (iii) determining if the deviation between r_{A,D} for the two groups is significant, wherein a significant deviation reflects a characteristic hub protein for a biological state, disease or disease stage. In another embodiment, the method includes calculating the average of the absolute value of r_{A,D} for the hub protein and each of its interactors before determining the existence of a deviation. In certain embodiments of this method, step (a) further comprises transforming the gene expression levels into a numerical or graphical form. In other embodiments of this method, step (b) and/or (c) is performed by a suitable programmed computer processor. For example, the computer program of Example 3 may be employed.

The invention also provides a method of assessing whether a patient is afflicted with or has a pre-disposition for a disease, in particular cancer, the method comprising comparing: (a) levels of co-expression of hubs and their interacting partners characteristic of the disease in a sample from the patient; and (b) reference levels of co-expression of hubs and their interacting partners characteristic of the disease in samples of the same type obtained from normal patients not afflicted with the disease, patients afflicted with the disease or at a different stage in the disease. In an embodiment, altered co-expression levels relative to the reference levels is an indication that the patient is afflicted with the disease. In another embodiment, substantially similar co-expression levels relative to the reference levels is an indication that the patient is afflicted with the disease.

In a further aspect, a method for screening a subject for a disease or disease stage is provided comprising (a) obtaining a biological sample from a subject; (b) detecting the amount of co-expression of hubs and interacting partners characteristic of the disease in the sample; and (c) comparing the amount detected to a predetermined standard or model. In an embodiment, detection of amounts of co-expression of hubs and interacting partners associated with the disease that differ significantly from the standard or model indicates the disease or disease stage. In another embodiment, detection of amounts of co-expression of hubs and interacting partners associated with the disease that are substantially similar to a standard or model indicates the disease or disease stage.

The invention provides a method for detection, diagnosis or prediction of a disease in a subject comprising: obtaining a sample of blood, plasma, serum, urine or saliva or a tissue sample from the subject; subjecting the sample to a procedure to measure levels of co-expression of hubs and interacting partners characteristic of the disease; detecting, diagnosing, and predicting disease by comparing the levels of hubs and interacting partners to the levels obtained from a control subject with no disease.

The invention also provides a method for assessing the aggressiveness or indolence of a cancer (e.g. staging), the method comprising comparing: (a) levels of co-expression of hubs and interacting proteins characteristic of the aggressiveness or indolence of the cancer in a patient sample; and (b) levels of co-expression of the hubs and interacting proteins in a standard or model.

In an embodiment, a significant difference between the co-expression levels in the sample and the standard or model is an indication that the cancer is aggressive or indolent. In another embodiment, substantially similar co-expression levels in the sample and the standard or model is an indication that the cancer is aggressive or indolent.

In an aspect, the invention provides a method for determining whether a cancer has metastasized or is likely to metastasize in the future, the method comprising comparing: (a) levels of co-expression of hubs and interacting partners characteristic of metastasis or likelihood thereof in a patient sample; and (b) levels (or non-metastatic levels) of the co-expression of hubs and interacting proteins in a standard or model.

In an embodiment, a significant difference between the levels in the patient sample and the standard or model is an indication that the cancer has metastasized or is likely to metastasize in the future. In an embodiment, substantially similar levels in the patient sample and the standard or model is an indication that the cancer has metastasized or is likely to metastasize in the future.

In another aspect, the invention provides a method for monitoring the progression of a disease, in particular cancer in a patient the method comprising: (a) detecting levels of co-expression of hubs and interacting proteins characteristic of the disease in a sample from the patient at a first time point; (b) repeating step (a) at a subsequent point in time; and (c) comparing the levels detected in (a) and (b), and therefrom monitoring the progression of the disease.

The invention contemplates a method for determining the effect of an environmental factor on a disease comprising comparing levels of co-expression of hubs and interacting proteins in the sample in the presence and absence of the environmental factor.

The methods of the invention may include the step of assigning a numerical value depending on whether the expression levels of hubs and interacting partners fall within or outside a reference network signature or levels for a standard of model. For example, a numerical value of 0 can be assigned to a sample if the expression levels are within the reference network signature or levels for a standard of model, and a positive value can be assigned where the expression levels are outside the reference network signature or levels for a standard of model. A positive value in some embodiments indicates a perturbed expression profile. As the number of hubs and interacting partners having expression levels outside the reference network signature or the levels for a standard or model increases, the assigned value will correspondingly increase. A sample or subject having a perturbed expression profile may indicate a disease state, a predisposition to developing a disease, a prognosis associated with a disease, or treatment of a disease and such a perturbed health state may be used to estimate the course of a disease. In some embodiments (e.g. where the standard or model represents a desirable category or classification), a positive value may indicate a favorable or normal profile which in the context of a disease or disease state may indicate the absence of a disease state or a predisposition to developing a disease, or a favorable prognosis or treatment of a disease.

The invention further relates to a method of assessing the potential efficacy of a therapy for inhibiting a disease in a patient. A method of the invention comprises comparing: (a) levels of co-expression of hubs and interacting proteins characteristic of the disease in a first sample from the patient obtained from the patient prior to providing at least a portion of the therapy to the patient; and (b) levels of co-expression of hubs and interacting proteins characteristic of the disease in a second sample obtained from the patient following therapy. In an embodiment, a significant difference between the levels of co-expression of hubs and interacting proteins in the second sample relative to the first sample is an indication that the therapy is efficacious for inhibiting the disease. In another embodiment, substantially similar levels of co-expression of hubs and interacting proteins in the second sample relative to the first sample is an indication that the therapy is efficacious for inhibiting the disease. The “therapy” may be any therapy for treating the disease, including but not limited to therapeutics, radiation, immunotherapy, gene therapy, and surgical removal of tissue. Therefore, the method can be used to evaluate a patient before, during, and after therapy.

The methods of the invention can be used to categorize or subcategorize drug responses in a population based on co-expression levels of hubs and interacting partners. A network signature can be generated using the methods of the invention that correlates network modularity and drug responses (e.g. changes in a sign or symptom of a disease). Methods of the invention for classifying a population by drug response can be used to stratify drug responses into, for example responder categories. These categories may be useful for predicting the effectiveness of a treatment, including the appropriate dosage or patient subpopulations for a treatment, or for optimizing a therapeutic regimen. The methods of the invention allow an early determination of drug responsiveness and evaluation of patients prior to an overt or full display of a drug response. These methods also permit a prediction of patient responsiveness as a companion diagnostic with other known diagnostic agents.

Thus, the invention provides a method of categorizing drug responsiveness in a population comprising (a) determining the expression levels of hubs and interacting partners for individuals in the population; (b) identifying a first group of individuals in the population that have a substantially similar response to the drug; (c) clustering the hubs and interacting partners by the drug response of the first group to generate a reference network signature indicating drug responses for the first group of individuals. A substantially similar response to a drug can refer to individuals having overt manifestations or indications that can be objectively determined by a physician (e.g. signs of a disease or a test result) or are based on subjective symptoms described by the individual. The method can further include the steps of (d) identifying a second group of individuals having a substantially similar response to the drug which differs from the drug response of the first group; and (e) clustering the hubs and interacting partners by the drug response of the second group to generate a reference network signature indicating drug responses for the second group of individuals. The method can further include optionally repeating steps (d) and (e) one or more times for an additional group or individuals having a substantially similar drug response that differs from other groups. In another aspect, this method may be used to determine how a particular drug or therapeutic, preadministered to a population, affects the network signature for a particular disease or disease state.

The invention also provides a method of predicting a drug response in an individual comprising (a) determining expression levels of hubs and interacting partners in a sample from the individual; (b) producing a network signature of informative hubs and their interacting partners; and (c) comparing the network signature with a reference network signature of drug responses to predict the drug response in the individual. In an embodiment, a network signature of the individual that is within or substantially similar to the reference network signature, indicates that the individual has or will have a substantially similar response to the drug as the reference population used for the reference network signature.

The invention further provides a method for assigning an individual to one of a plurality of categories in a clinical trial comprising determining for the individual co-expression of hubs and interacting partners in a sample from the individual; producing a network signature of informative hubs and their interacting partners; comparing the network signature with reference network signatures of reference populations that have different clinical categories; and assigning the individual to a category in the clinical trial based on correlation of the network signature with one or more reference network signature.

The invention also provides pharmacogenetic methods for determining suitable treatment regimens for diseases, in particular cancer, and methods for treating cancer patients, based around selection of patients according to the methods of the invention.

A method of the invention that provides a network signature may be used as a readout in animal model based screening methods for new therapeutic approaches and compounds. In an aspect of the present invention, a network signature is utilized to predict the efficacy of potential new treatments in animal models for disease states.

The present invention also provides a method for evaluating the efficacy of, or validating or predicting the utility of an animal model of a disease for elucidating strategies, pathways, processes and guiding the development of hypotheses for testing in a target animal. The method may comprise comparing a network signature generated for an animal model of a disease using a method of the invention and a network signature of a population of the target animal suffering from the disease.

The methods of the invention may further employ other data along with the network modularity signature. For example, in classifying a disease state, data including without limitation, patient age, stage of disease, molecular or genetic subtype and other like data.

Methods of the invention may be used in diagnostic methods performed in a physician's office or in a clinical laboratory. They can also be used in remote diagnostic methods in which the step of measuring the co-expression of hubs and interacting partners is separated from the step of analyzing the co-expression in reference to a standard or model or reference network signature. The measurement and analysis steps may be coordinated via a network such as the internet.

In an aspect, the invention relates to methods for assigning a sample to a prognostic class and methods for classifying a sample obtained from a subject in a prognostic class using a method or scheme described herein. Once a sample from a subject is classified in a prognostic class, then a healthcare provider can determine the proper course of treatment for the subject.

The invention provides a business method for obtaining regulatory review of a drug comprising: (a) determining hubs and their interacting partners that significantly discriminate among responders and non-responders to the drug; (b) using results from step (a) to determine whether a patient would benefit from administration of the drug; and (c) combining information from prior regulatory filings for the drug in combination with information from the association in step (b) to support a new drug approval regulatory filing. This method in one embodiment is performed by a suitably programmed computer processor. In one embodiment, the method employs all or a portion of the code defined in Example 3. In a business method of the invention, the prior regulatory filings may be filed in the United States or in a country outside of the United States. A business method of the invention may further comprise marketing the drug with a diagnostic test, wherein the diagnostic test stratifies a patient population that displays a network signature that supports a treatment regimen with the drug, and stratifies the patient population so that a subset of the patient population that is likely to benefit from treatment with the drug is identified. The method may identify a subset of a population comprising individuals for whom results from the diagnostic test predict no adverse event if treated with the drug or predict an efficacious response if treated with the drug. The business method may further comprise the step of collecting royalties from sales of the drug.

In certain embodiments, any and all of the methods described herein is computer-implemented and thus the invention provides computer systems, computer programs, computer-readable data media and laboratory robots or evaluating devices for the any of the methods of the invention.

In one embodiment, a system comprises a computer processor capable of processing gene expression data for a hub protein and its interacting partners, an input device, an output device, and a memory capable of storing computer-readable instructions, wherein the contents of the memory comprises computer-readable instructions that if executed are capable of directing the computer to: (a) receive gene expression levels data from a biological sample from a subject; (b) determine the relative expression of a hub protein and an interacting partner in the sample; (c) compare the relative expression to a standard or model; and (d) output an indication of the presence of a biological state, a disease or disease stage, likelihood thereof, or prognosis therefor. In another embodiment, this system directs the computer to repeat step (b) and/or (c) for additional interacting partners with the hub protein, and for additional hub proteins and their interacting partners. In some embodiments, steps (b) and (c) are performed with multiple hubs and interacting partners. In one embodiment, the resulting output indication is a network signature or subset thereof characteristic of a biological state, a disease, or a disease stage. In one embodiment of this system, the computer-readable instructions comprise the computer program of Example 3.

In another embodiment, a system comprises a computer processor capable of processing gene expression data for a hub protein and its interacting partners, an input device, an output device, and a memory capable of storing computer-readable instructions, wherein the contents of the memory comprises computer-readable instructions that if executed are capable of directing the computer to: (a) receive gene expression level data from a reference population having two different biological states, diseases or disease stages; (b) divide reference population gene expression levels into two groups, each group characteristic of one different biological state, disease or disease stage; (c) determine the relative gene expression of a hub protein and an interacting partner in the groups; (d) assess differences in relative gene expression levels between a hub protein and an interacting partner in the groups to identify a hub protein whose expression relative to an interacting partner is characteristic of one different biological state, disease or disease stage; (e) optionally repeat steps (c) and/or (d) for additional interacting partners with the hub protein, and for additional hub proteins and their interacting partners; and (f) output a network signature useful in identifying a biological state, disease or disease stage. In one embodiment of this system, the computer-readable instructions comprise the computer program of Example 3. In an embodiment, steps (c) and (d) are performed with multiple hubs and interacting partners.

In another embodiment, a computer-readable medium comprises computer-readable code that if executed is configured to: (a) compare the relative expression of a hub protein and an interacting partner detected in a subject's sample to a standard or model characteristic of a biological state, disease or disease stage; and (b) provide an indication of a biological state, disease or disease stage in the subject based upon the comparison. This computer-readable medium, in certain embodiments, contains computer-readable code configured for additional interacting partners with the hub protein, and for additional hub proteins and their interacting partners. In one embodiment of this medium, the computer-readable code comprises the computer program of Example 3.

In another embodiment, a computer-readable medium comprises computer-readable code that if executed is configured to: (a) receive gene expression level data from a reference population having two different biological states, diseases or disease stages; (b) divide reference population gene expression levels into two groups, each group characteristic of one different biological state, disease or disease stage. For example, in one embodiment, one group is composed of poor outcome subjects having or being treated for a cancer and the other group is composed of good outcome subjects successfully treated for the cancer. Successful treatment can include a disease-free state or survival with the disease for a significant period of time, post-diagnosis. Additional steps which the medium is configured to execute are: (c) determine the relative gene expression of a hub protein and interacting partners in the groups; (d) assess differences in relative gene expression levels between a hub protein and an interacting partner in the groups to identify a hub protein whose expression relative to an interacting partner is characteristic of one biological state, disease or disease stage; (e) optionally repeating steps (c) and/or (d) for additional interacting partners with the hub protein, and for additional hub proteins and their interacting partners; and (f) provide a network signature (or a subset thereof) useful in identifying a biological state, disease or disease stage. In an embodiment of this method, steps (c) and (d) are performed with multiple hubs and interacting partners. In one embodiment of this medium, the computer-readable code comprises the computer program of Example 3.

In an aspect, the invention pertains to a method for use in a computer system for classifying at least one sample obtained from an individual. The method comprises providing a model which correlates classes (e.g. biological states) and co-expression of hubs and their interacting partners; assessing a sample for co-expression of hubs and their interacting partners; and using the model to classify the sample comprising comparing the co-expression of informative hubs and their interacting partners to the model to thereby obtain a classification. The methods further comprise cross-validation of the model by eliminating or withholding samples used to build the model; building a cross-validation model for classifying without eliminating samples and using the cross-validation model classifying the eliminated samples into a winning class by comparing the co-expression values of hubs and their interacting partners of the eliminated samples based on the cross-validation model classification of the eliminated samples. The methods may further comprise filtering out any hub and interacting partner co-expression values in the sample that exhibit an insignificant change and normalizing the co-expression values. The method may also comprise providing an output indicating the classes.

The invention also relates to a computer apparatus for classifying a sample into a class, wherein the sample is obtained from a subject, wherein the apparatus comprises a source of co-expression values of hubs and their interacting partners in the sample, a processor routine executed by a digital processor coupled to receive the gene co-expression values from the source, the processor routine determining classification of the sample by comparing the co-expression values of the sample to a model built to correlate the co-expression values with co-expression of hubs and interacting partners characteristic of the class; and an output assembly coupled to the digital processor for providing an indication of the classification of the sample.

Another aspect of the invention provides a computer apparatus for constructing a model for classifying at least one sample to be tested having hub and interacting partner co-expression values, wherein the apparatus comprises a source of hub and interacting partner co-expression values from two or more samples belonging to two or more classes, the source being a series of hub and interacting partner co-expression values for the samples; a processor routine executed by a digital processor, coupled to receive the hub and interacting partner co-expression values from the source, the processor routine determining hubs and interacting partners for classifying the sample, and constructing the model with a portion of the informative or relevant hubs and interacting partners using a correlation scheme. The apparatus can further comprise a filter coupled between the source and the processor routine for filtering out any of the hubs and interacting partners that are not significant. The output assembly can be a graphical representation which may be in colour.

The invention also provides a machine readable computer assembly for classifying a sample into a class, wherein the sample is obtained from an individual, wherein the computer assembly comprises a source of hub and interacting partner co-expression values of the sample, a processor routine executed by a digital processor, coupled to receive the co-expression values from the source, the processor routine determining classification of the sample by comparing the co-expression values of hubs and interacting partners in the sample to a model; and an output assembly coupled to the digital processor for providing an indication of the classification of the sample. The invention also provides a machine readable computer assembly for constructing a model for classifying at least one sample to be tested having hub and interacting partner co-expression values, wherein the computer assembly comprises a source of co-expression values from two or more samples belonging to two or more classes the source being a series of hub and interacting partner co-expression values for the samples, a processor routine executed by a digital processor coupled to receive the co-expression values of the vectors from the source, the processor routine determining relevant hub and interacting partners from the co-expression values for classifying the sample and constructing the model with a portion of the relevant hub and interacting partners by using a correlation analysis.

The invention further provides a kit for performing a method of the invention. A kit may comprise a microarray for assaying levels of informative hubs and interacting partners and a computer system for comparing the levels with a standard, model or reference network signature. The computer system may comprise a processor and a memory encoding one or more programs coupled to the processor wherein the one or more programs cause the processor to perform a method comprising computing the aggregate differences of co-expression between the sample and a reference population or a method comprising determining the correlation of co-expression of the hubs and interacting partners to the co-expression in a reference population. In an aspect, the kit is able to distinguish samples from patients with a good disease prognosis from samples from patients with poor prognosis. Thus, the invention provides a kit for determining whether a sample is derived from a subject having a good prognosis or a poor prognosis comprising at least one microarray comprising genes encoding hubs and interacting partners characteristic of prognosis of a disease and a computer readable medium having recorded thereon programs for determining the similarity of the co-expression of informative hubs and interacting partners in the sample to that in a reference population of individuals having a good prognosis or a poor prognosis wherein one or more programs cause a computer to perform a method comprising computing the aggregate differences in co-expression of the informative hubs and interacting partners between the sample and the reference population or a method comprising determining the correlation of the co-expression in the sample to the co-expression in the reference population.

All of the above methods and compositions may be utilized in combination with other known diagnostic reagents, compositions and methods to identify biological states, diseases and disease states, or to predict the likelihood of particular responsiveness of a subject to therapeutic regimens, or the likelihood of recurrence of a disease or the degree of severity of disease or biological state. The methods described herein may be used to confirm diagnoses made utilizing other methods and reagents or to assist in differential diagnoses of biological states, diseases and disease stages. One of skill in the art may select from among all known diagnostic reagents and methods for combination with the methods described herein.

The following non-limiting examples are illustrative of the present invention:

### Example 1

The following materials and methods were used in the study described in the Examples.

Data Integration to Determine PCC of Co-Expression in Interaction Networks

A method analogous to that previously described was used¹³. The complete interactome from OPHID⁹ as well as subsets of interactions interologue mapped from yeast to mad⁴¹ or just literature curated interactions¹¹ was downloaded as well as expression data from 79 human tissues⁸. Hubs were selected as those with greater than 5 interactions, as these proteins are in the top 15% of the degree distribution of the network. For each hub the average PCC of co-expression for each interaction and the hub was assessed using a similar algorithm as previously described¹³. Random re-assignment of the expression values to nodes in the network was used to ascertain if the observed network was nonrandom. The network was visualized using Cytoscape 2.5.1⁴².

GO Functional Similarity of Hubs and their Interactors

Semantic similarity between hubs and their interactors was calculated by combining the similarity scores between the GO terms annotated to each protein. Lin GO similarity measures were used to compute GO term similarity using the GraSM approach where for each term of each of the proteins only the most similar term of the other protein is used to compute a composite average⁴³.

Topological Network Analysis

Betweeness and Characteristic Pathlength of networks were calculated using previously described algorithms using the tYNA web interface¹⁹. When assessing network robustness to hub removal, an equivalent number of intermodular and intramodular hubs were removed from the network in order of descending clustering coefficient. To validate that the two hub classes are distinct, length, phosphorylation, linear motifs, globularity, and domain architecture were investigated (see Supplemental Methods below). These were either computed directly from the hub sequence or by mapping to the appropriate database. Significance levels were computed by sampling (see Supplemental Methods below).

Distribution of Hub Types by Human Disease Phenotypes

Entries in OMIM²⁴ for each hub gene was extracted and subsequently manually curated for 1) hubs associated with cancer, malignancy or metastatisis 2) found to be involved in oncogenic translocation fusions.

Network Analysis Between Breast Tumour Samples

To determine the essential network misregulated between breast cancer patient outcome (alive without disease vs. dead from disease), a non-parametric algorithm was used to sample hub behaviour between groups of samples. Briefly, the absolute difference of the PCC of two groups of a hub and each of its interactions was calculated as well as 1000 random re-assignments of patients into equally sized groups. P-value cut-off and degree cut-off for hubs were optimized as a function of accuracy during cross validation runs. Patients were clustered using an affinity propagation algorithm⁴⁴. Kaplan-Meier survival curves were drawn for groups defined by the algorithm using patient survival data and drawn using SPSS v14.0.

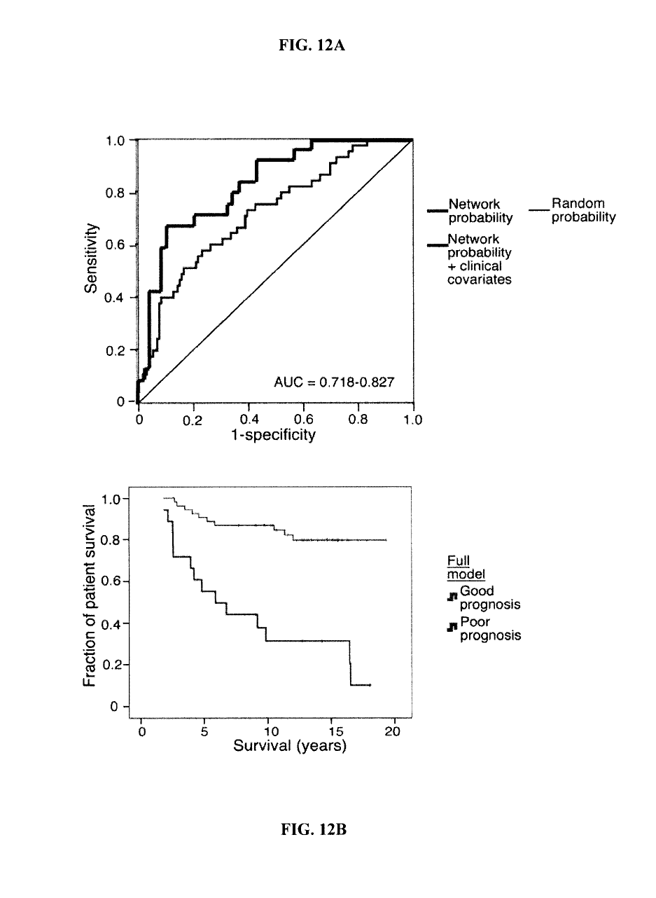

A classification algorithm was trained to identify patterns in expression of genes interacting with the hub that were predictive of prognosis and the ability of the algorithm to predict the patient outcome was assessed using 5-fold cross-validation. Specifically, the patient network data and clinical outcome were partitioned into five approximately equally-sized portions; the algorithm was trained on four of these portions, holding out one of the portions for testing. To test the algorithm, only the gene expression data for patients in the hold-out set was provided and its predictions of clinical outcome compared with the actual outcomes for these patients. This procedure was repeated for each hold-out set, amassing unbiased outcome predictions for every patient. To measure the variability in predictions, the 5-fold cross validation procedure was repeated three times with different random partitions of the data. The algorithm first identifies hubs based on their number of neighbours, k, and then assigns each a score, p, equal to the significant difference of hub correlation with its interactors between alive patients and those who died of disease when compared to a random distribution. The algorithm then selects a subset of the hubs by applying a cutoff top; subtracts the hub expression level from those of all its interactors; and clusters the hub-subtracted expression levels of interactor genes using affinity propagation⁴⁴. To evaluate the accuracy of the algorithm, the hub-subtracted expression levels of patients in the hold-out set are clustered along with the patients in the training set and the predicted probability of a poor outcome in these patients is set to be the proportion of patients from the training set in their cluster who experienced a poor outcome. The performance of this classifier was calculated using different thresholds for p and minimum hub degree (k), and it was found that the best performance of test set classification was achieved when k=7 and p=0.09 was used for training set parameters (FIG. 11) at which the average area under the Receiver Operator Characteristic curve (AUC) was 0.711. Similar performance was seen at a variety of levels of k and p cutoffs, for example at a typical (un-optimized) setting of k=5 and p=0.05, the average AUC was 0.661. As expected, randomization of the data resulted in the algorithm not performing at all (AUC ˜0.500).

Supplemental Methods: Data Integration to Determine PCC of Co-Expression in Interaction Networks

A method analogous to that previously described was used¹³. The complete interactome from STRING¹⁰ or OPHID⁹ as well as subsets of interactions interologue mapped from yeast to man⁴¹ or just literature curated interactions¹¹ was downloaded as well as expression data from 79 human tissues⁸. Duplicate gene expression spots from the GeneAtlas data for a particular gene were averaged. A degree (k) cut off of greater than or equal to 5 was used since this represents the highest 15% of the degree distribution of hubs. For each hub the average PCC of co-expression for each interaction and the hub was assessed using a similar algorithm as previously described¹³. The entire OPHID database⁹ and human GeneAtlas expression data⁸ and matched gene expression data and protein interactions via NCBI gene IDs were downloaded. The Pearson Correlation Coefficient of each interaction of each hub was calculated by:

Let X_{I}_{ⱼ}=expression data of interactor I of hub H for tissue j=1, 2, 3 . . . n
Let X_{H}_{ⱼ}=expression data for hub H for tissue j=1, 2, 3 . . . n

$${r}_{I , H} = \frac{{\sum }_{j = 1}^{n} ( {X}_{{I}_{j}} - {\overline{X}}_{I} ) ( {X}_{{H}_{j}} - {\overline{X}}_{H} )}{( n - 1 ) {s}_{I} {s}_{H}}$$

$$where {\overline{X}}_{I} = \frac{{\sum }_{j = 1}^{n} {X}_{{I}_{j}}}{n}$$

$$and {\overline{X}}_{H} = \frac{{\sum }_{j = 1}^{n} {X}_{{H}_{j}}}{n}$$

$$and {S}_{I} = \sqrt{\frac{{\sum }_{j = 1}^{n} ( {X}_{{I}_{j}} - {\overline{X}}_{I} )}{( n - 1 )}}$$

$$and {S}_{H} = \sqrt{\frac{{\sum }_{j = 1}^{n} ( {X}_{{H}_{j}} - {\overline{X}}_{H} )}{( n - 1 )}}$$

where I is a interactor of hub H and j denotes the expression data for the hub or interactor in each of n tissues, and the summation is over all tissues (j=1, 2, 3 . . . n). s_{I}s_{H} is the product of the standard deviations of the expression data for the hub and interactor. The average over all n_{H} interactors for hub H was taken as:

$$AvgPCC = \frac{{\sum }_{I = 1}^{{n}_{H}} {r}_{I , H}}{( {n}_{H} - 1 )}$$

where r_{I,H} is the correlation of each interaction across n tissues. The network was visualized using Cytoscape 2.5.1⁴².

Supplemental Methods: Selection of a Cut-Off Point Between Inter- and Intramodular Hubs

The probability density of the average PCC represents the underlying frequencies of hub average PCCs. Therefore, the cut off was chosen as the local minimum of the frequency distribution between the two peaks of the maxima frequency. Hubs within +/−0.5 standard deviations of the average PCC were excluded as they could not be unambiguously described as either inter or intramodular hubs.

Supplemental Methods: Random Reassignment of Expression Data

Random reassignment of the expression data was taken by randomly shuffling the expression data gene labels. This method of random reassignment retains the topological network structure of the interactome during the randomization.

Supplemental Methods: Topological Network Analysis

Betweenness and Characteristic Pathlength of networks, which measures their connectivity, were calculated using previously described algorithms using the tYNA algorithm¹⁹. Betweenness of a node n is defined as the number of node pairs (n₁,n₂) where the shortest path from n₁ to n₂ passes through node n, if and only if, the graph is undirected and the shortest path is not counted as passing through the end nodes. CPL reflects the connectivity across the network and is defined as the median value of the minimum pathlengths required to go from node n₁ to n₂. A custom Python script was used to employ the batch version of tYNA by looping over all hub proteins. To attack the network, intermodular and intramodular hubs were removed in descending order of clustering coefficient. This network attacking method is similar to the one used to interrogate intermodular and intramodular hub behaviour in the yeast proteome as previously described¹³. The clustering coefficient is defined as:

Where E is the set of edges in the graph, n is a node and ON(n) is the set of nodes such that for each n′ in ON(n), n′< >n and there is at least 1 edge from n′ to n.

Then:

$$ClusterCoeff ( n ) = \frac{[ {\sum }_{{n}_{1} {n}_{2} ∈ ON ( n ) , {n}_{1} \neq {n}_{2}} I ( ( {n}_{1} {n}_{2} ) ∈ E ) ]}{[ \vert ON ( n ) \vert \times ( \vert ON ( n ) \vert - 1 ) ]}$$

Supplemental Methods: Biochemical Features of Human Hub Proteins

In order to avoid sampling biases and over-counting of features (linear motifs, domains, etc.) associated with the hub classes a redundancy reduction was performed of both the intramodular and intermodular hub sets. This was done using the CD-HIT algorithm by comparing all protein sequences within a hub class to all other sequences within the same class and removing any member of the class with more than 90% sequence similarity to any other member. To validate that the two hub classes are biologically distinct, length, phosphorylation sites⁴⁶ and other linear motifs²¹, globularity⁴⁷, and domain architecture²² were investigated within the redundancy reduced hub classes. The hub classes were analyzed by splitting them into three partitions (intermodular hubs, intramodular hubs and unknown, where unknown are hubs that could not confidently be assigned as intermodular hubs or intramodular hubs). Sets of Python and Perl scripts, BLAST and the database mentioned below were utilized to perform analysis of the following biochemical features of the hub proteins. These features were either predicted from the hub protein sequence or mapped from the mentioned databases. Significance levels were assessed by sampling as described below.
a) Phosphorylation sites. First, all hub proteins were mapped to phospho.ELM (v6, 2006) by reciprocal BLAST searches. A cutoff of 100 was used for the bitscore and it was demanded that the second-best hit was 50 below the best-match. Subsequently, the number of known phosphorylation sites within a hub was extracted from Phospho.ELM. Significant differences between intermodular and intramodular hubs were determined by sampling 10e⁶ times from the combined hub set and determining whether the mean number of sites for a hub class was significantly higher or lower than what would be expected if there were no two distinct classes. Secondly, the NetworKIN algorithm was used to predict the number of phosphorylation sites for which kinases could be assigned. Previously, it was shown that even without experimental validated phosphorylation sites this algorithm can predict novel/potential sites with highly significant enrichment (compared to random)⁴⁶. Thus the Python version of NetworKIN was used to predict the number of sites for each hub and sampling was subsequently performed as described above to determine significance levels.
b) Linear motifs. The literature curated data set of experimentally validated instances of linear motifs from the ELM²¹ database was used. The set was matched (using BLAST as above) to the hub sequences and subsequently the number of ELM instances in each sequence was determined. The significance in differences between intermodulars and parties was estimated by sampling as described above.
c) Domain architecture. The domain architecture of hub proteins was determined by searching the SMART²² set of Hidden Markov Models (HMMs) against the hub sequences. This was performed by a custom build search pipeline using Python scripts as clients for a text-pipeline at SMARTs webserver (EMBL, Heidelberg). Hand annotated lists of domains involved in signaling were used to discriminate architectural differences between the hub classes. These lists were primarily based on the annotation within SMART with some additional curation. Sampling was used to estimate the significance of different domain compositions of the two hub classes as described above. This pipeline was also used to determine the number of residues residing in known globular domains (in contrast to predicted globular regions as below).
e) Globularity and disorder. Two previously published algorithms for detecting intrinsic protein disorder from sequence (GlobPlot, DisEMBL) were used. Both of these algorithms were deployed using pipeline versions written in Python. The number of residues residing in disordered regions was counted and the significance between the hubclasses by sampling was determined as above.

Supplemental Methods: Gene Ontology Similarity Between Hubs and their Interactors

Semantic similarity between protein pairs was calculated by combining the similarity scores between the GO terms annotated to each protein. Lin-GraSM similarity measures were used to compute GO term similarity⁴⁵. These measures are based on the concept of information content (IC), which was calculated for each term according to the expression:

IC_{c}=−log₂(f_{c})

where f_{c} is the frequency with which the term is annotated within the UniProt database. The IC values were normalized by dividing by the scale maximum. Lin-GraSM similarity between two terms is given by a ratio between the terms average IC and that of their disjunctive common ancestors:

$${sim}_{LinG} = \frac{Avg ( {IC}_{Ancestors} )}{Avg ( {IC}_{Terms} )}$$

All terms of the first protein are paired with each term of the second one, and all similarity scores are used to produce an average:

SSM_{AVG}=Avg_{i,j}└sim(termⱼ,termⱼ)┘

Supplemental Methods: Distribution of Hub Types by Human Disease Phenotypes

Entries in OMIM²⁴ for each hub were extracted and subsequently manually curated for 1) hubs associated with cancer, malignancy or metastatisis 2) found to be involved in oncogenic translocation fusions. Equally, hubs were extracted from the census of cancer genes²⁵. Hubs associated with cancer were normalized for the frequency of each hub type and significant differences in the distribution of hubs between cancer and non-cancer genes was determined by the Fisher's exact test.

Supplemental Methods: Network Analysis of Breast Tumour Samples

To determine the hubs that significantly discriminate between patients who are alive without disease and dead of disease, a non-parametric test was established. First the original patient data²⁶ was filtered to remove patients that were alive with disease by removing patients that had metastases but did not die from breast cancer at last time of follow up and patients that did not requisitely die of disease by removing patients who died without metastases and thus could not be confirmed to be dead from disease. This filtering resulted in a cohort of 255 patients (from 296 in the original study²⁶, 181 alive without disease and 74 dead of disease. The expression data was median centered and expression value was matched with the protein-protein interaction data by mapping to NCBI geneID. Each hub was assessed for the difference of the PCC of each interaction by the following equation:

$${r}_{A , D} = ( \frac{\sum ( {I}_{A} - \overline{I} ) ( {H}_{A} - \overline{H} )}{( {n}_{A} - 1 ) {s}_{{I}_{A}} {s}_{{H}_{A}}} ) - ( \frac{\sum ( {I}_{D} - \overline{I} ) ( {H}_{D} - \overline{H} )}{( {n}_{D} - 1 ) {s}_{{I}_{D}} {s}_{{H}_{D}}} )$$

where I and H denote the expression of an interactor and a hub respectively and A is the group of patients who are alive without disease whereas D is the group of patients who died of disease. The summations are over the number n_{A} or n_{D} of patients in each group, and s_{IA}s_{HA} and s_{ID}s_{HD} are the products of the standard deviations of the hub and the interactor expression for the alive and dead groups respectively. The average of the absolute value of r_{A,D} for the hub and each of its interactors is given by:

$$AverageHubDiff = \frac{{\sum }_{n} \vert {r}_{A , D} \vert}{n - 1}$$

where n is the number of interactors for a given hub. This metric gives us an estimate of the difference in correlation of each interaction around a hub between the two groups (alive without disease vs. dead of disease). To determine if the deviation in correlation between the two groups is significant, patients were randomly reassigned to the two groups 1000 times and the AverageHubDiff was recalculated. Therefore, the p-value of each hub was given as the frequency of the random AverageHubDiff being greater than the real AverageHubDiff divided by 1000.

To evaluate if the genes in the significant hubs have been previously implicated in breast cancer pathology the number of publications of the included hubs were examined by searching the PubMed database using NCBI gene name and “breast cancer”. This measure was corrected for the total number of publications by simply searching the NCBI gene name of the included hubs in the PubMed database. The ratio of included hubs in the breast cancer literature/total publication of included hubs was evaluated against an equivalent number of excluded hubs (hubs with a P≧0.91) and evaluated for the prevalence in the breast cancer literature while controlling for total publications for those genes.

Supplemental Methods: Assessment of Individual Patients

To evaluate the dynamic network properties of each significant hub in each patient the algorithm was adapted to measure the difference in co-expression of the hubs and each interactor of those hubs found to be significantly different between patients dead of disease and alive without disease using the following equation:

InteractionDiff=Iₙ−H

where the difference is taken of the expression of each of n interactors, Iₙ, from each significant hub, H, and all significant hubs are evaluated.

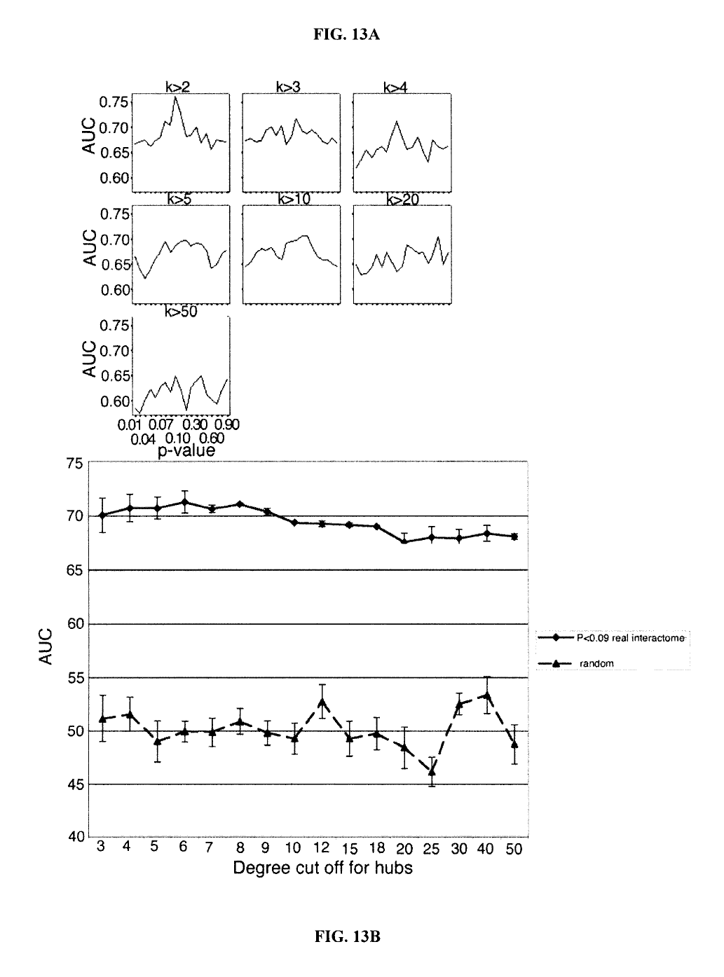

Patient data were then clustered using the affinity propagation⁴⁴ algorithm using the set of expression differences of significant hubs and their interactors as inputs using a 5-fold cross validation strategy. Briefly, the patients were randomly assigned to five approximately equal groups. Four of the five groups were used to train the algorithm including hub selection and affinity propagation clustering of the training set. The test group was then clustered using the training set probability groups. The performance of the algorithm at correctly categorizing the test set patients was evaluated by plotting the sensitivity and 1—specificity at all possible probability cut offs. To determine which cutoff should be used for hub degree (k) and p-value for significant hubs, 3 runs of 5-fold cross validation were run at several p-value cut-offs and degree cut-offs. To evaluate which p-value cut off to use for selecting hubs for clustering, the algorithm performance was assessed across an array of p-value cut offs and degree cut offs (FIG. 13A). A peak in performance is observed across most degree cut-offs at a p-value of 0.09. At a p-value of 0.09, 256 hubs where selected to assess patient modularity differences since this represented 9% of the total hub population. To evaluate the effect of degree cut-off on determination of hub status AUC with hubs of greater than or equal k between 3 and 50 was evaluated (FIG. 13B). Both the predictive power and the inter-cross-validation standard error is optimal at k≧7(FIG. 13B, upper line). The performance of the algorithm was evaluated when the interactome was randomized by randomly reassigning the gene IDs to the existing interactome. This method of randomization retains the topological structure of the interaction network whilst randomly assigning expression data to the network. Such network randomization resulted in approximately no predictive performance (AUC ˜0.5, FIG. 13B, lower line).

For generation of Kaplan-Meier curves, patients were assigned a prognosis probability based on the frequency training set patients in each cluster who were alive without disease or dead of disease. Probabilities of poor outcome of >0.4 were assigned to the poor prognosis groups as this cut off consistently resulted in the highest predictive performance. The prognosis probabilities were further tested in binary logistic regression models with other clinical covariates including tumour grade, tumour size, number of positive lymph nodes and patient age to control for differences in tumour sample at the time of excision. Cut offs for the regression equation were evaluated and the highest accuracy of prediction was used as a cut-off (probability >0.4)

### Results:

### Establishing Network Modularity in the Human Interactome

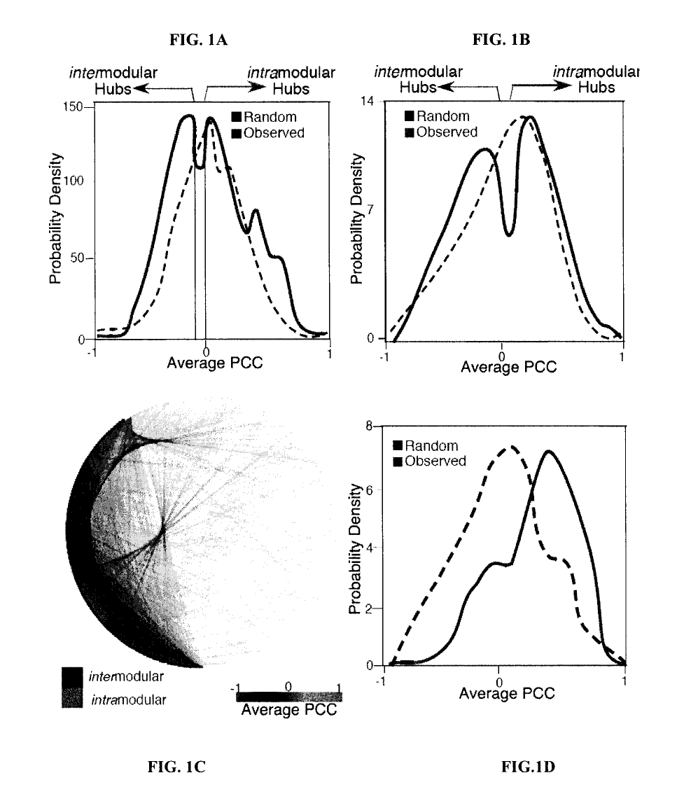

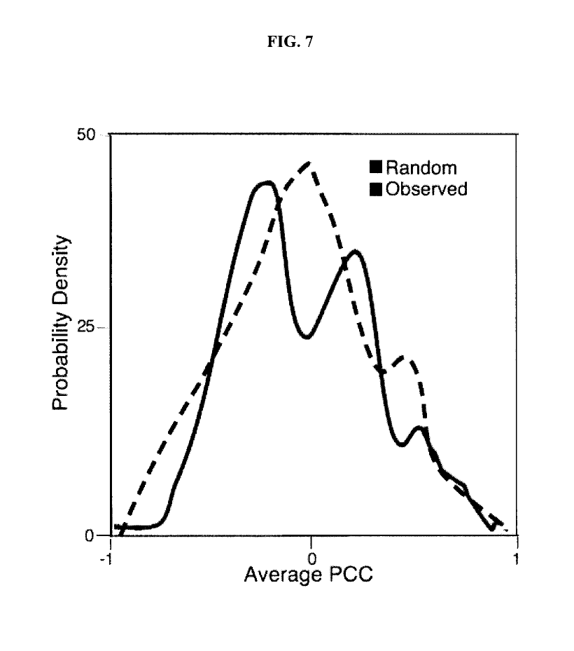

To investigate global alterations in interactome assembly, it was first sought to determine if biological context manifested by changes in gene expression affect the structure of the interactome. To do so, genome-wide expression data taken from 79 human tissues⁸ with a large set of hub proteins (defined as proteins having 5 or more interacting partners) taken from both literature-curated and high throughput (HTP) sources⁹ (FIGS. 1A and 1C) were overlaid. The average Pearson Correlation Coefficient (PCC) of co-expression of the hub and each of the interacting partners was analyzed as a measure of whether interactions are either context specific (i.e., interactors are not co-expressed) or constitutive in all scenarios (i.e., interactors are co-expressed). The average PCC of coexpression of the human hubs revealed a multi-modal distribution, with distinct populations of hubs centred over increasing average PCC values. In contrast, a randomized reassignment of the expression data to the same network resulted in an approximately normal distribution (FIG. 1A, black dashed line). Of note, the shoulder evident in the randomized analysis is due to a number of very high degree, highly correlated genes in this dataset (such as proteasome and ribosome subunits) that during randomization have a high probability of forming interactions with true interactors. Indeed, a shoulder in the randomized dataset is not observed when these high degree nodes are removed (data not shown). Also, a similar multi-modal distribution was observed using a separate high confidence human PPI database¹⁰ (FIG. 7), while analysis of a literature-curated source alone¹¹ (FIG. 1B) revealed clear bimodality. These findings indicate that there are distinct classes of hubs in the human interactome, those that display low correlation of co-expression with their partners, termed intermodular hubs, as first proposed in the analysis of the yeast interactome^{12, 13}, and those that display relatively higher correlation of coexpression, or intramodular (FIG. 1A). The human interactome thus displays features of a modular architecture. Of interest, when this analysis was constrained to only hubs with interactions that are conserved between yeast and humans, a single peak over relatively high average PCC is observed. Thus, conserved hubs are largely intramodular hubs (FIG. 1D). This is in agreement with previous analysis that showed that the assembly of intramodular hubs into macromolecular complexes constrains their evolution¹². This is further evidenced in the human interactome as a large cluster of highly correlated interactions interconnecting intramodular hubs (FIG. 1C; darker edges adjacent dark lower left quadrant nodes).

### Organizational Properties of Intra- and Intermodular Hubs

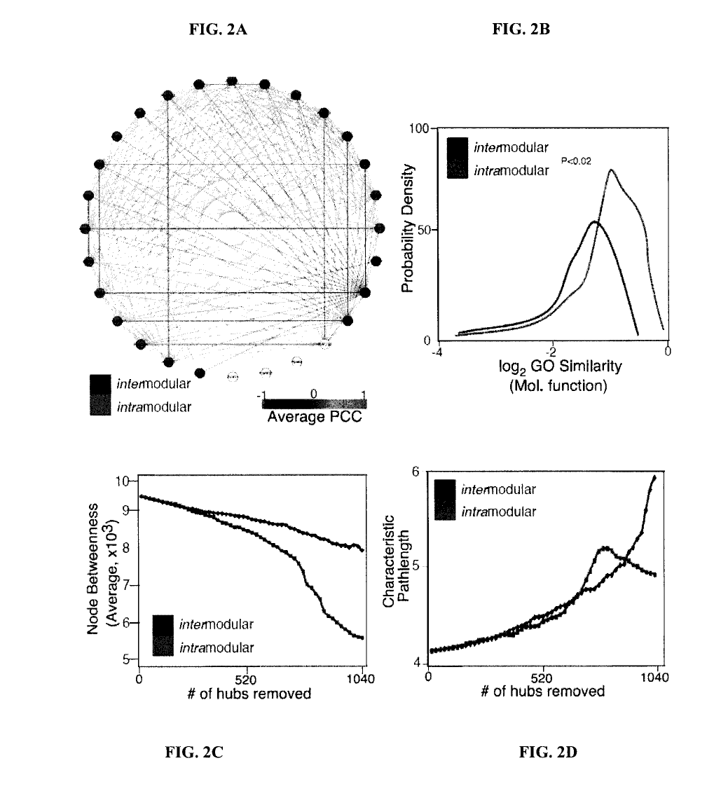

Modular structure in interactomes has been proposed to confer higher order function to the network, such that intermodular hubs provide for temporally and spatially restricted linkages to intramodular hubs that in turn fulfill specific functions, often as multi-subunit macromolecular machines^{14, 15}. For example, most components of the 26S proteasome show highly correlated expression, and function together to mediate protein degradation (FIG. 2A). However, 3 hub components, PSMB1, PSMB2 and PSMD9 are intermodular, which reflects their previously described tissue specific modulation of the proteasome^{16, 17}. To directly test whether intramodular hubs have more functional similarity with their partners throughout the interactome, hubs and their interactors were examined using semantic similarity of the Gene Ontology Molecular Function database¹⁸. Intramodular hubs were found to have greater molecular functional similarity with their interactors compared to intermodular hubs (student's t-test, P<0.02, FIG. 2B).

Intermodular hubs, by providing dynamic structure to modular interactomes, have also been proposed to be critical for global network connectivity and regulation. To test this in the human network, the interactome was attacked by removing either intermodular hubs or intramodular hubs in descending order of clustering coefficient and betweenness of the resulting network was analyzed¹⁹. Betweeness is a measure of information flow through networks, with high betweenness reflecting multiple paths between all nodes and low betweenness few pathways connecting network nodes. Betweenness also measures the centrality of a node in a network thus expressing its importance as an intersection between all parts of the network. In a biological framework betweenness measures how functional complexes communicate with each other. In the human interactome, selective removal of intermodular hubs resulted in rapid decay of betweenness in the network when compared to removal of intramodular hubs (FIG. 2C). Similarly, when the characteristic path length (CPL; the median of the minimum number of jumps between nodes to get from one end to the other of a single network) was analyzed, systematic removal of intermodular hubs yielded a threshold where CPL rapidly collapsed due to splintering of the larger network into small clusters. In contrast, intramodular hub removal only increased CPL and never led to network collapse (FIG. 2D). A rapid decline in both CPL and Betweenness indicates network collapse, which occurs when the original, single, highly inter-connected network fragments into sub-networks that are isolated from each other due to loss of intermodular hubs.

Together these results demonstrate that the human interactome is modular in nature with intermodular hubs interacting between functional modules that are comprised of intramodular hubs.

### Biochemical Features are Reflected in Hub Type

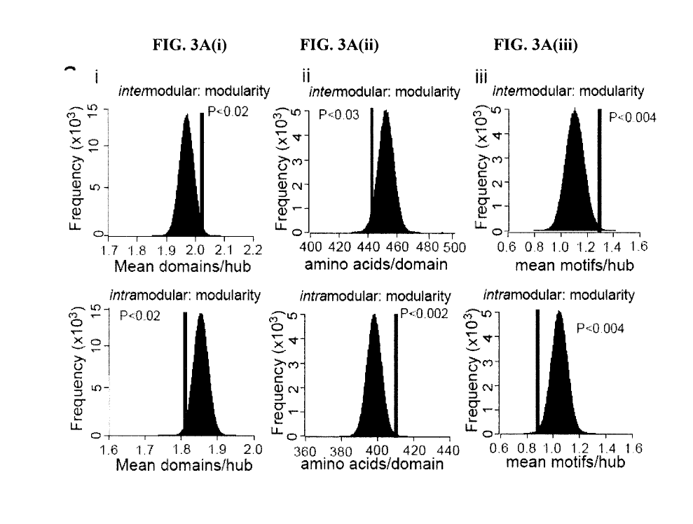

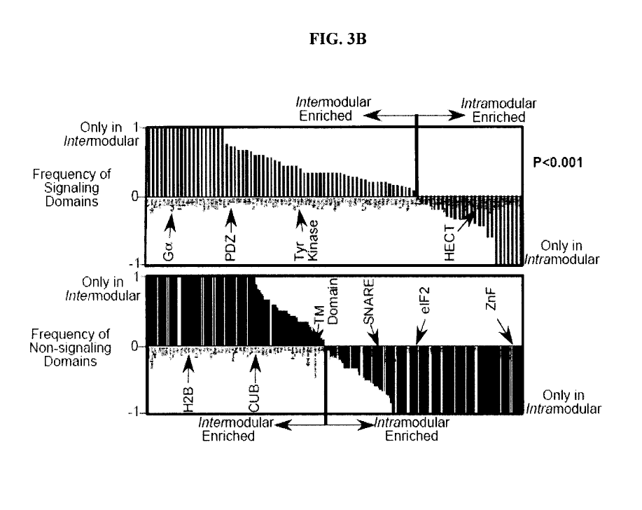

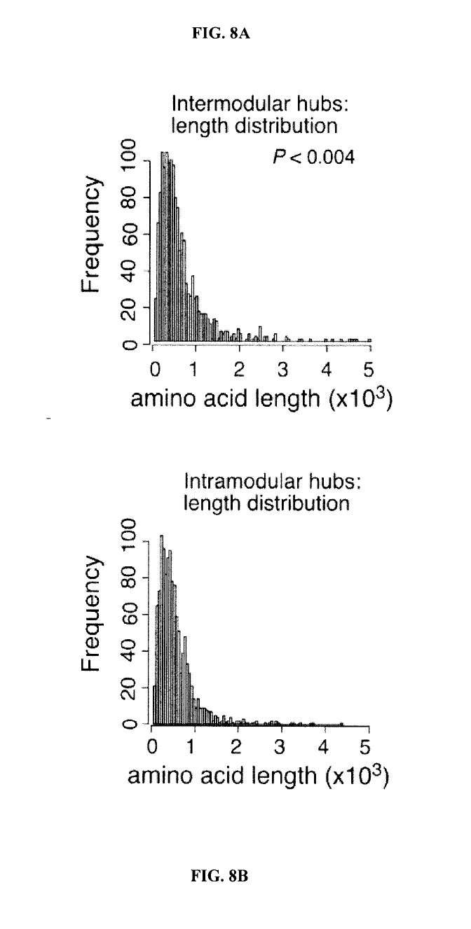

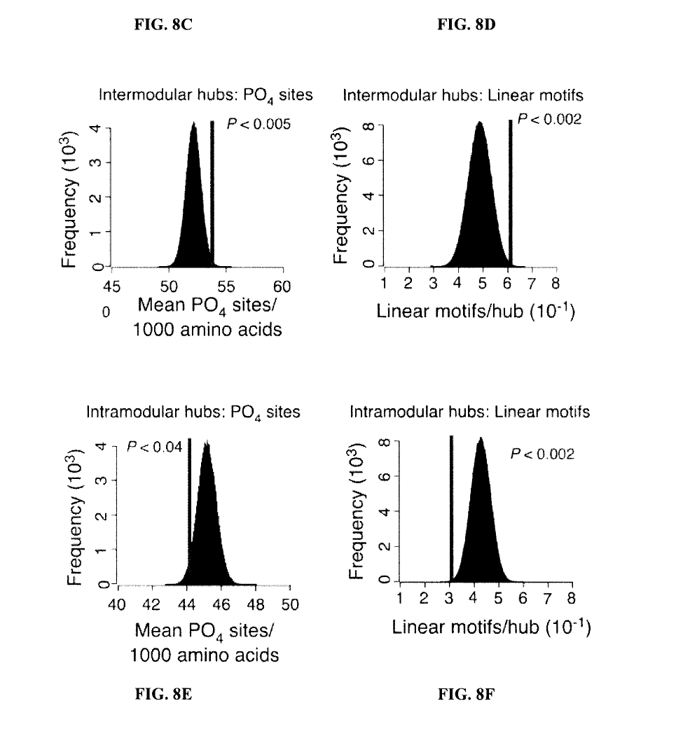

The full compendium of human interactions is not known, leading to the suggestion that topological features such as modularity may be artefacts of analyzing incomplete datasets²⁰. Although analysis of three different datasets of human interactions all revealed evidence of modularity, it was sought to assess whether there were distinct biochemical and genetic features that might distinguish hub types. On average, intermodular hub proteins have a greater amino acid sequence length than intramodular hub proteins (Mann-Whitney U-test, P<0.005, FIGS. 8A and 8B). Analysis of the number of domains (modularity) and size of domains (globularity) further revealed that intermodular hubs have more domains and higher modularity compared to a randomized distribution, whereas intramodular hubs have less domains than would be expected by chance (P<0.05 and P<0.01 respectively, FIG. 3A(i)). Conversely, intramodular hubs have greater globularity and intermodular hubs less (P<0.05 and P<0.01, respectively; FIG. 3A(ii)). The ELM and Phospho.ELM database²¹ were also queried for differences in the distribution of sequence motifs associated with experimentally validated post-translational modifications that include phosphosites and short binding motifs (collectively termed linear motifs). Linear motifs were found to be significantly over-represented in intermodular hubs and under-represented in intramodular hubs (P<0.005, FIG. 3A(iii)). Similar differences were found when phosphosites or linear motifs where examined independently (FIGS. 8C, 8D, 8E and 8F). In summary, these results indicate that intermodular hubs are bigger, have more individual domains and more linear motifs, which can facilitate their engagement in dynamic interaction networks. Next the types of domains present in intermodular or intramodular hubs were explored.

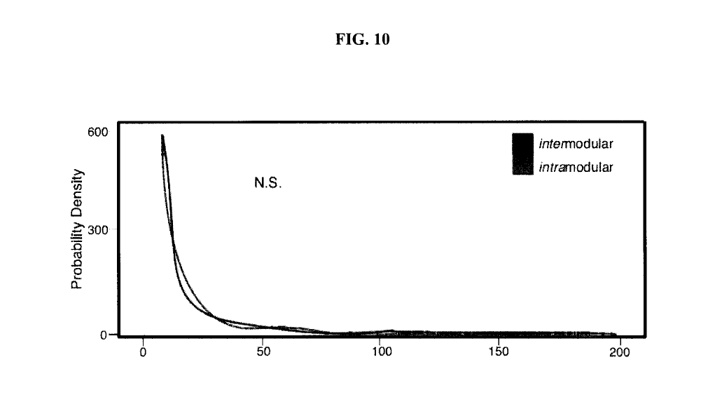

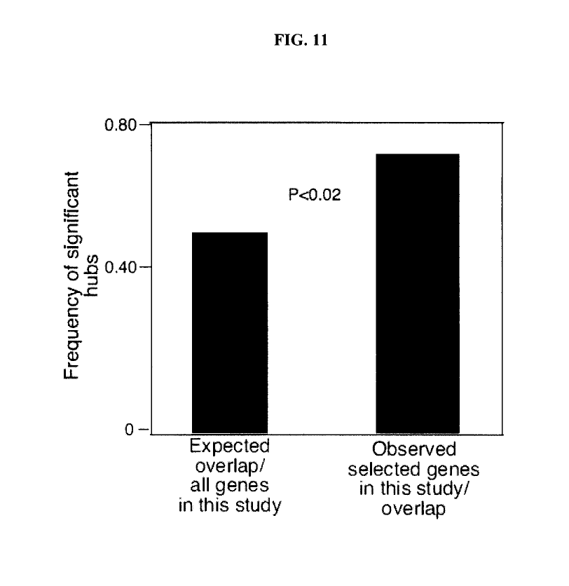

Domains associated with cell signaling (as defined in the SMART Database²²) were found to be significantly enriched in intermodular hubs (binomial sign test, P<0.001), compared to non-signaling domains, which are evenly distributed between the hub types (FIG. 3B). For example, tyrosine kinase, PDZ and Gα domains were found predominantly, and in some cases, exclusively in intermodular hubs (FIG. 3B). The degree distribution of the two hub types were analyzed to ensure that the observed differences in domain architecture and linear motifs were not a function of the number of interactions of inter and intramodular hubs (FIG. 10). This revealed no significant difference, indicating that biochemical attributes of hubs are an inherent property of the hub type and not the degree distribution. These results indicate that intra- and intermodular hubs display distinctive structural and functional characteristics that likely reflect their roles in organizing the local versus global properties of signaling networks.

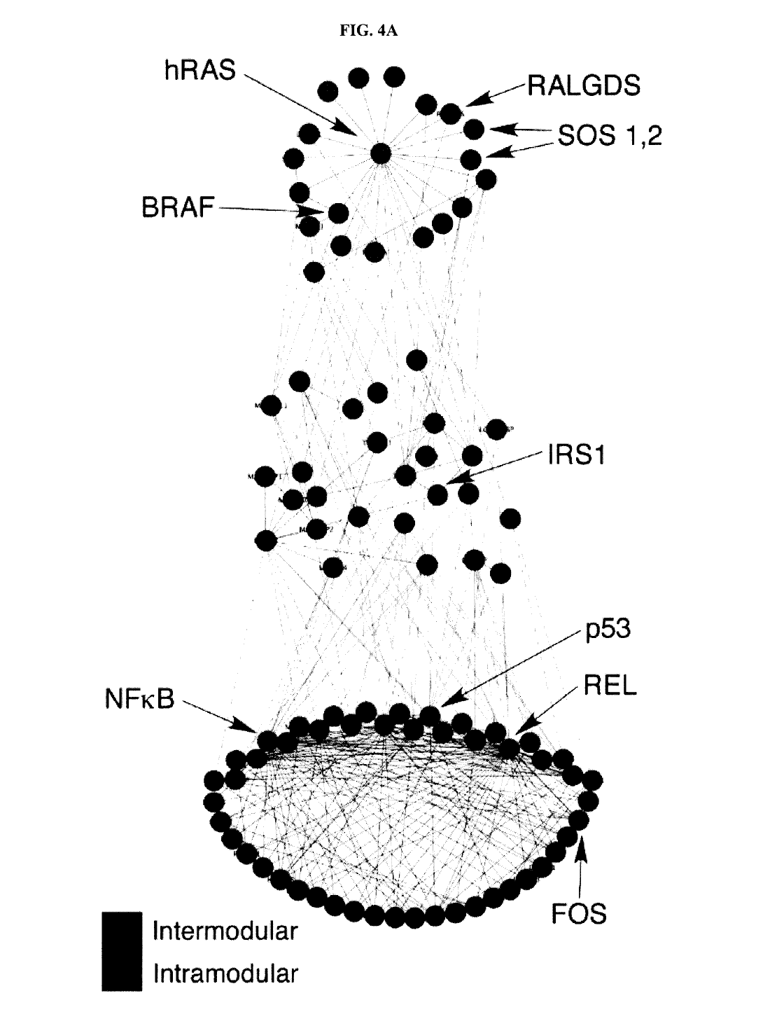

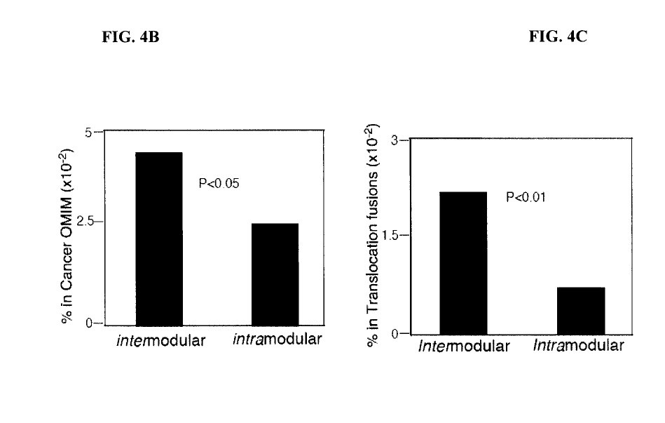

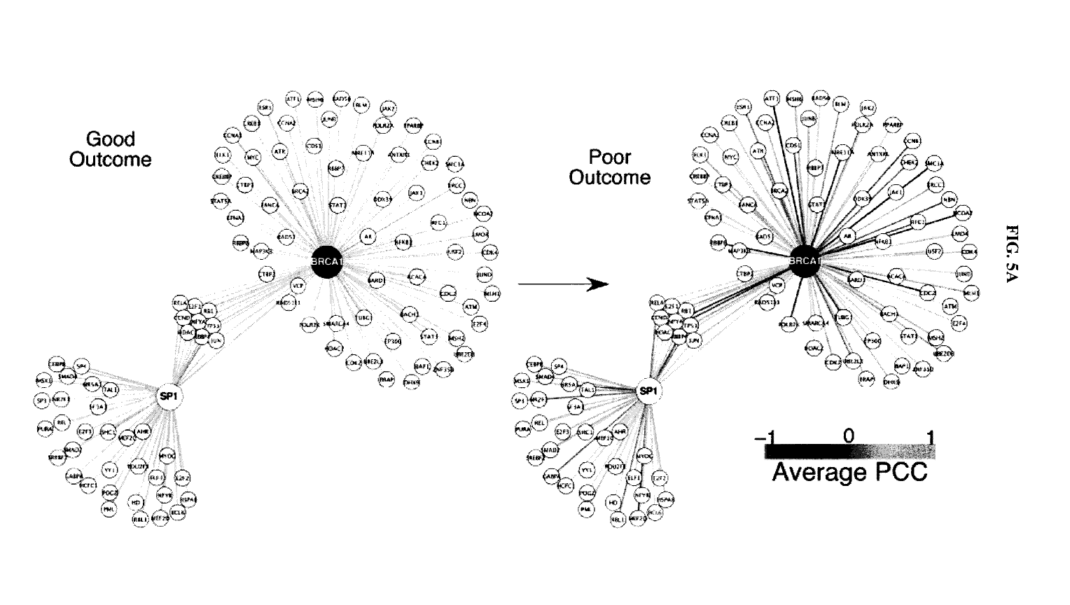

To explore this organization the well-characterized RAS subnetwork was examined. This revealed RAS to be an intramodular hub, with most of its highly correlated partners representative of regulators of RAS activity, such as RALGDS and SOS (FIG. 4A). In contrast, partners that employ RAS as either a downstream effector (e.g., the Insulin receptor adaptor protein, IRS1²³), or as an upstream regulator (i.e. BRAF²³) tended to be intermodular hubs. These intermodular hubs in turn connected to a much larger cluster of intramodular hubs enriched in transcription factors, such as NFκB, RELA, FOS and p53. Also notable in the signaling network highlighted in FIG. 4A is the sparsity of direct connections between the RAS module and the downstream intramodular cluster, with virtually all interactions occurring via intermodular hubs. This suggests that signaling networks are assembled in a modular fashion with intermodular hubs organizing the interconnectivity of functional modules such as RAS and the downstream RAS transcriptional effectors.

Disturbance of Network Modularity is Associated with Breast Cancer Outcome

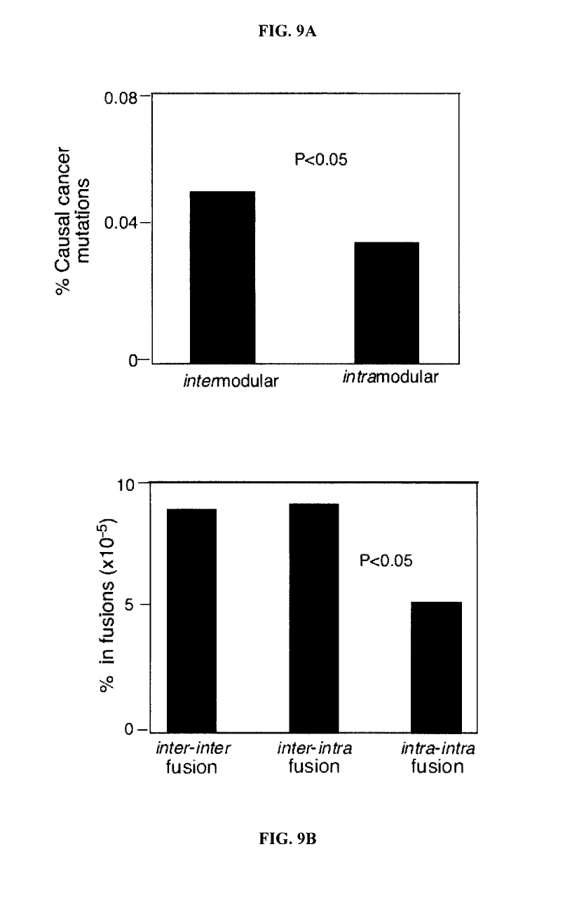

The analysis of the human interactome suggests that intermodular hubs are enriched for signaling domains and control global connectivity and information flow within the network (for example, betweenness and CPL). During oncogenic transformation rewiring of signaling networks has been proposed to drive the phenotypic alterations associated with tumour progression whilst maintaining the robust features of the network¹⁴. Given the key role of intermodular hubs in coordinating signaling within the interactome, it was considered whether there are differences in the association of hub type with cancer by querying the OMIM²⁴ for association of intermodular and intramodular hubs with cancer. This revealed that mutations in intermodular hubs were associated with cancer phenotypes more frequently than intramodular hubs (Fisher's exact test, P<0.05, FIG. 4B). Similarly, mutations found in the census of human cancer genes²⁵, as well as the number and type of oncogenic translocation fusions, were all associated with intermodular hubs (Fisher's exact test, P<0.01, FIGS. 4B, 4C, 9A and 9B). As intermodular hubs are key regulators of global functions in a modular network, these results suggest that disturbances in network modularity may be a target in complex diseases such as cancer.

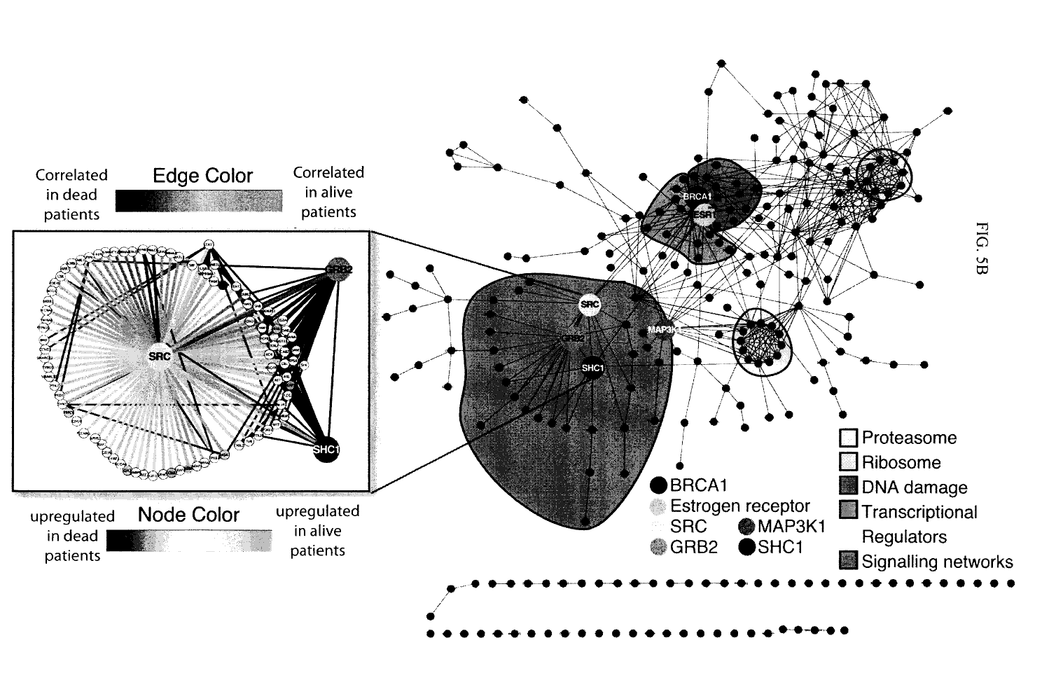

To examine whether transitions in hub status (i.e. alterations in modularity) are associated with poor prognosis in cancer a well-described cohort of sporadic breast cancer patients²⁶ was used. Significant differences in the average PCC of hubs and their interacting partners in patients that were disease-free after extended follow up, versus those that died of disease were first looked for. This revealed 256 hubs that displayed significantly altered PCC as a function of disease outcome. One of the hubs identified in this analysis was BRCA1, which is mutated in a subset of familial breast cancers. Analysis of BRCA1 modularity revealed high correlation of co-expression with its partners in tumours with good outcome, compared to reduced correlation in poor outcomes (FIG. 5A). This is contrasted by the transcription factor Sp1 that was not significantly changed. Of the BRCA1 partners highly correlated in good outcome tumours, both MRE11 and BRCA2 are notable as they are important members of the BRCA1-associated genome surveillance complex (BASC) and have been shown to be individually misregulated in poor prognosis breast cancer^{27,28}. However, the results further suggest that disorganization of the BASC complex (FIG. 5A), not through mutation of members of the complex such as BRCA1, MRE11 or BRCA2, but by loss of co-ordinated co-expression of components, is associated with poor outcome in breast cancer.

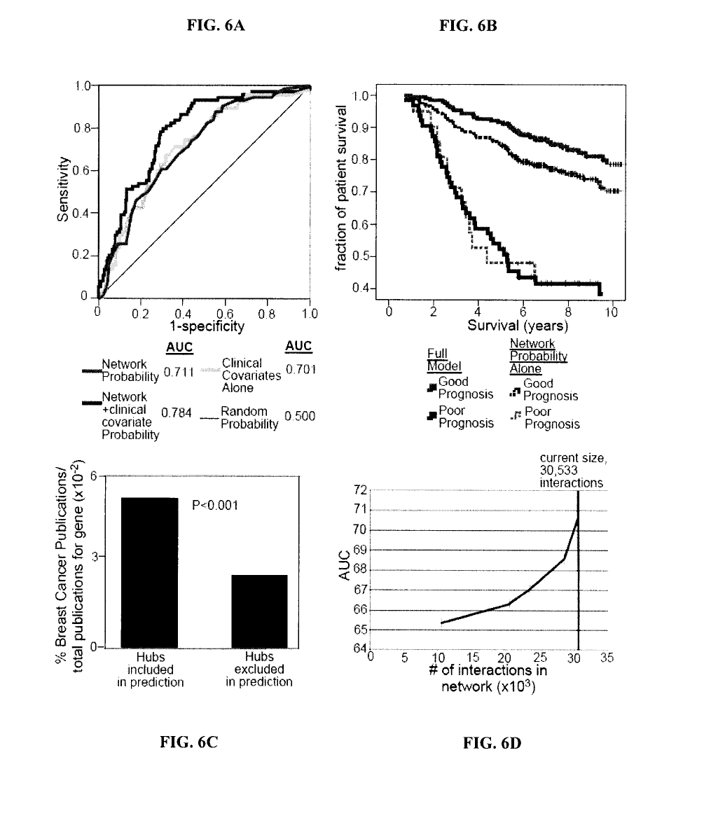

Next, protein interactions between all the significant hubs identified in this analysis were examined. This uncovered a highly inter-connected “circuit” that contains many hub proteins known to be important for the pathogenesis of breast malignancies (FIG. 5B). This includes hubs involved in signaling networks, such as MAP3K1 (MEK kinase), GRB2, SHC and SRC; Estrogen signaling (ESR1); the DNA damage response (BRCA1, RAD51, MRE11); proteasome components and ribosomal components. Many of these genes have been found to be mis-regulated in breast cancer progression. For example, genome-wide association studies recently identified SNPs in MAP3K1 associated with breast cancer susceptibility²⁹. Further unbiased analysis of the entire aberrantly regulated network demonstrated that components were over-represented in the breast cancer literature (FIG. 6C, Fisher's exact test, P<0.001) and in previous microarray studies^{4, 26, 30, 31} of breast cancer prognosis (FIG. 10, Fisher's exact test, P<0.02) when compared to an equally sized network of hubs that did not change significantly between groups. Of note, the analysis does not identify hubs based on significant up or down regulation of genes between the good and poor outcome groups, but rather identifies differences in co-expression between interacting proteins between groups. Of the 256 hubs identified in the study, only 23% (59 hubs) showed significant alteration of expression in the cohort when analyzed using default settings of Significance Analysis of Microarrays³². For example, no significant difference in the expression level of the SRC oncogene between groups was observed (FIG. 5B, inset). However, the aberrant co-ordinated co-expression of SRC and it's regulators or effectors (for example, Protein Kinase Cc (PRKCE)—see FIG. 5B inset) was clearly affected. These results show that there is a dynamic reorganization of the interactome caused by alterations in co-ordinated co-expression that is associated with poor outcome in breast cancer.

### Dynamic Network Modularity is a Prognostic Signature

The inventors determined that the altered dynamic network modularity that was identified provides a prognostic signature in breast cancer patient tumour samples. To develop an algorithm to assess hub behaviour in individual patients, the relative expression of hubs with each of their interacting partners was taken. Identification of the hubs that were significantly different between patients that survived versus those that died from disease was determined. In turn the relative expression for hubs and their partners was used in an affinity propagation clustering algorithm to generate a probability of poor prognosis for each patient. The algorithm was employed in a 5-fold cross-validation strategy in which ⅘ of the patient data was randomly selected as a training set with subsequent testing on the hold-out set. In this strategy, the hub selection process was incorporated on the training set within the cross-validation loop to avoid over-fitting problems. Triplicate runs were performed using three different randomized test sets and the average performance was analyzed using receiver operator characteristic (ROC) curves. This revealed a typical area under the curve (AUC) value of 0.711 (FIG. 6A). In comparison, a prospective study of the 70-gene signature resulted in an AUC of 0.648 in prediction of breast cancer survival³³. The cross-validation performance of this algorithm was compared with the retrospective³⁴ or prospective³³ performances of commercially available genomic breast cancer diagnostics. The accuracy, sensitivity and specificity of this algorithm compared favorably against other breast cancer gene signatures (76%, 86% and 81%, accuracy, sensitivity and specificity, respectively, versus 53%, 41% and 68%³³ and 70%, 71% and 67%³⁴).

Efforts to map the human protein-protein network are in their infancy and current physical maps likely reflect only a small fraction of the full interactome. Therefore, assay performance was assessed as a function of interactome complexity, by analyzing networks in which hubs were randomly removed. This revealed that removal of hubs reduced assay performance (FIG. 6D), suggesting that the prognostic accuracy is limited by the density of the current interactome. This suggests that expansion of the known human interactome, in particular by unbiased systemic approaches to mapping interactions will not only lead to new biological insights of breast cancer such as the recent link between HMMR and BRCA1⁶ but also increase the prognostic capabilities of this algorithm.

The “poor outcome” probabilities were used next to group patients into two prognostic groups. Probability of prognosis was set at greater than or equal to 0.4 since at this cut off the algorithm consistently yielded the highest accuracy of prediction. Analysis of these two groups revealed the 5-year survival was significantly different (Mantel-Cox Log Rank test, nominal P<0.001) with only 44% of patients possessing the poor prognosis modularity signature expected to survive disease free for more than 5 years (FIG. 6B). Conversely, greater than 83% of patients with a good prognostic network signature survived disease free for 5 years. The average overall error rate of prognosis using the test set data at this prognostic cut off is 29.1%. Next it was asked whether incorporation of clinical data at the time of surgical resection could be employed along with the modularity signature to improve performance. For this, clinical data was incorporated in a logistic regression model with the network probability values. Incorporating patient age, tumour stage and tumour grade (TNM classification³⁵) in assigning prognostic group membership increased performance (AUC=0.784) (FIG. 6A) and enhanced prognostic classification of patients (error rate: 25%; FIG. 6B). Further examination of the cross-validated use of the clinical covariates alone showed that the current clinical prognostics perform comparably with the network probability score (AUC=0.701, FIG. 6A). However, there is increased performance when they are combined, indicating that the prognostic value of current clinical measures is enhanced with the use of network probability scores.

Finally, the cross-validation analysis was repeated using a separate cohort of breast cancer patients (TransBIG³³). Strikingly, the algorithm showed comparable, if not improved, performance compared to the original breast cancer patient cohort (AUC 0.718-0.827; FIG. 12A, accuracy of 78.5%) and comparable Kaplan-Meier Survival curves for predictive good and bad prognosis. Thus, >80% of predicted good prognosis patients survived past 10 years compared to <35% of those falling in the poor prognosis group (FIG. 12B). By comparison, analysis of the same cohort using the 70-gene signature², 76-gene signature³⁶ and the Gene expression Grade Index³⁷ breast cancer signatures³⁸ revealed that each signature had approximately equal prognostic performance (average accuracy of poor outcome prediction at 10-years of 55.4%). These results demonstrate that the molecular changes of the tumour that are captured by measuring differences in dynamic modularity of the interaction network are significant and independent predictors of patient disease outcome and that measuring these changes can improve the predictive value of prognostic indicators already in use in the clinic.

### Example 2

A study has been conducted utilizing the fractal nature of the human protein-protein interaction network. Previous examinations of real world networks revealed that many complex networks display fractal behavior. The networks are self similar regardless of scale. To determine if the human protein-protein interaction network is indeed fractal, published methods⁴⁷ were applied.

The 3 conditions that are required to be satisfied to define a fractal network were met with the human protein-protein interaction network identified in Example 1. Those conditions are:

(1) The number of boxes needed to cover the original, the skeleton, and the Random Spanning Tree (RST)), exhibit power law relationship to the size of the box. A skeleton network is a network that has been trimmed of many vertices but retains the vertices of the nodes with the highest betweenness centrality. A random spanning tree (RST) is also a network trimmed of many vertices but unlike the skeleton no choice is made with regards to the vertices that remain as long as all the nodes can be connected to the network via the remaining vertices.

(2) The number of boxes needed to cover the original and the skeleton is almost the same.

(3) The fractal dimension (power coefficient of the best fitting power function) of the Random Spanning Tree (RST) is almost the same as the fractal dimension of the original network.

Furthermore, synthetic networks of similar but deliberately different properties of the real human interaction network did not display fractal properties as defined above. For example such a synthetic network has an equivalent number of nodes that did not have a scale-free but Gaussian distribution of degrees for the node.

The human interaction network that was previously shown with the prediction algorithm was found to displays fractal properties. Thus, it was hypothesized that other self similar subnetworks (i.e., the skeleton network or RST) are sufficient to predict the outcome of the breast cancer patients using the algorithm described herein. Therefore, the previously described algorithm (i.e. Example 1) was applied. Instead of using the full interaction network, subset networks of the RST or skeleton were used. Based on measuring the area under the curve of the receiver operator curve of the 5-fold cross validation runs, the predictive power of the algorithm was equivalent when the whole network was used as well as the skeleton network. This suggests that the information contained within the whole network is imbedded in the simplified skeleton network. Conversely, when the RST was used as the interaction network data, the predictive power was greatly reduced. This suggests that necessary power for making prediction on biological outcome (e.g., breast cancer patient outcome) is lost when the whole network is trimmed using an RST.

This example suggests that instead of using the whole human interaction network to perform the prediction described in previous iterations of the algorithm as in Example 1, the method can be performed with similar accuracy and provide the same predictions simply by use of the skeleton network.

### Example 3

An example of computer code useful to implement the methods described herein is reproduced below:

```
npHubTest
function hubsGreater = npHubTest(data,labels,intmatrix,minHub);
npHubTest - finds significant hubs using non-parametric test
  HUBSGREATER = findSigHubs(DATA, LABELS, INTMATRIX,
  MINHUB)
Input Arguments:
  DATA:
      A N × P matrix where N is the number of genes and P is the
      number of patients/observations
  LABELS:
      A binary vector (0's and 1's) denoting group separations.
  INTMATRIX:
      A binary matrix (assumed sparse) denoting which gene
      pairs have known interactions between them.
  MINHUB:
    The minimum degree f or something to be considered a hub
Output Arguments:
  HUBSGREATER:
      A binary vector denoting which hubs had corrs within group
      were greater on this run than the random group
NOTE: This should generally only be called from findSigHubs.
randlabels = labels(randperm(length(labels)));
hubsGreater = zeros(1, size(data, 1));
Indices of “hubs”
idx = find(sum(intmatrix) >= minHub);
hubdata = data(idx,:);
for ii = 1:size(hubdata,1),
  %randlabels = labels(randperm(length(labels)));
  interactors = find(intmatrix(idx(ii),:));
  curr = [hubdata(ii,:)‘,data(interactors,:)’];
  e1 = corrcoef(curr(labels == 1,:));
  e2 = corrcoef(curr(labels == 0,:));
  e3 = corrcoef(curr(randlabels == 1,:));
  e4 = corrcoef(curr(randlabels == 0,:));
  v1 = mean(abs(e1(1,2:end) − e2(1,2:end)));
  v2 = mean(abs(e3(1,2:end) − e4(1,2:end)));
  hubsGreater(idx(ii)) = v1 > v2;
end;
findSighubs
function [hubs,pval] = findSigHubs(data,labels,intmatrix,minHub,repeat,
p,test);
FINDSIGHUBS--Find significant hubs based on non-parametric test
[HUBS, PVAL] = findSigHubs(DATA,LABELS,INTMAT,MINHUB,
REP,P,TICK)
  Input Arguments:
  DATA:
      matrix of gene expression measurements of size N × P, where N
      is the number of genes and P is the number of patients/observations
  LABELS:
      Binary vector of length P containing class assignments as
      1's and 0's (alive/dead or luminal/basal).
  INTMAT:
      Binary PPI matrix, 1 indicates interaction, 0 indicates no
      interaction
  REP:
      Number of times to repeat the randomization test
  P:
      Significance level (i.e. 0.05)
  Output Arguments:
  HUBS: Indices of the rows in DATA corresponding to significant
  hubs at level P
  PVAL: Estimated p-values corresponding to each hub in HUBS
if nargin < 7,
      test = ‘labels’;
end;
counts = zeros(1,size(data,1));
for ii = 1:repeat,
      if strcmp(test,‘network’),
          counts = counts + npHubTest2(data,labels,intmatrix,minHub);
      else,
          counts = counts + npHubTest(data,labels,intmatrix,minHub);
      end;
end;
hubs = find(counts > (repeat − p * repeat));
pval = (repeat − counts) / repeat;
pval = pval(hubs);
```

### EXTRACTFEATURES_NOAVERAGE

```
function features = extractFeatures_noAverage(data, interactions,
sigHubs);
EXTRACTFEATURES_NOAVERAGE-- Given a list of hubs and
expression data, extract a matrix of features
[AVGDIFF] = extractFeatures(DATA, INTERACTIONS, SIGHUBS);
Input Arguments:
DATA:
      An N × P matrix of expression levels, N is number of genes
      and P is number of patients/observations
INTERACTIONS:
      Binary PPI matrix, 1 indicates interaction and 0 indicates
      no interaction
SIGHUBS:
      Vector of indices corresponding to rows of DATA that are
      significant hubs
$Id: extractFeatures.m 4 2007-05-10 17:33:56Z dwf $
features = [ ];
for ii = sigHubs,
  interactors = find(interactions(ii,:));
  newfeatures = repmat(data(ii,:),length(interactors),1) − ...
    data(interactors,:);
  features = [features; newfeatures];
end;
```

cluster_classify
function probs=cluster_classify(data, labels, newpts, maxlabel);
CLUSTER_CLASSIFY—Clusters data and takes majority vote among labels of closest cluster to test point

PROBS=CLUSTER_CLASSIFY(DATA, LABELS, NEWPTS, MAXLABEL)

DATA is a matrix where columns represent training datapoints, rows are features. LABELS is a vector of positive integer labels. NEWPTS is a matrix of the same sort as DATA with the same number of rows (though not necessarily the same number of columns) of data points not present in DATA, i.e. the test points we are trying to classify. MAXLABEL is an optional parameter which should be specified if not all labels are represented in the LABELS vector (i.e. this is one fold in a cross-validation that may not have representatives from every class).

```
if nargin < 5,
  maxlabel = max(labels);
end;
if nnz(labels == 0),
  labels = labels + 1;
  maxlabel = maxlabel + 1;
  shift = 1;
end;
dists = distance(data, data);
clusters = apcluster(−dists, median(−dists), ‘plot’,‘maxits’,300);
[centers, junk, junk2] = unique(clusters);
dist_to_newpts = distance(data(:,centers),newpts);
[val, ind] = min(dist_to_newpts);
assignments = centers(ind);
for ii = 1:length(assignments),
  probs(:,ii) = hist(labels(clusters == assignments(ii)), 1:maxlabel)’;
end;
probs = probs ./ repmat(sum(probs),size(probs,1),1);
```

apcluster
[idx,netsim,dpsim,expref]=apcluster(s,p)
APCLUSTER uses affinity propagation (Frey and Dueck, Science, 2007) to identify data clusters, using a set of real-valued pair-wise data point similarities as input. Each cluster is represented by a data point called a cluster center, and the method searches for clusters so as to maximize a fitness function called net similarity. The method is iterative and stops after maxits iterations (default of 500—see below for how to change this value) or when the cluster centers stay constant for convits iterations (default of 50). The command apcluster(s,p,‘plot’) can be used to plot the net similarity during operation of the algorithm.
For N data points, there may be as many as N̂2−N pair-wise similarities (note that the similarity of data point i to k need not be equal to the similarity of data point k to i). These may be passed to APCLUSTER in an N×N matrix s, where s(i,k) is the similarity of point i to point k. In fact, only a smaller number of relevant similarities are needed for APCLUSTER to work. If only M similarity values are known, where M<N̂2−N, they can be passed to APCLUSTER in an M×3 matrix s, where each row of s contains a pair of data point indices and a corresponding similarity value: s(j,3) is the similarity of data point s(j,1) to data point s(j,2).

APCLUSTER automatically determines the number of clusters, based on the input p, which is an N×1 matrix of real numbers called preferences. p(i) indicates the preference that data point i be chosen as a cluster center. A good choice is to set all preference values to the median of the similarity values. The number of identified clusters can be increased or decreased by changing this value accordingly. If p is a scalar, APCLUSTER assumes all preferences are equal to p. The fitness function (net similarity) used to search for solutions equals the sum of the preferences of the data centers plus the sum of the similarities of the other data points to their data centers. The identified cluster centers and the assignments of other data points to these centers are returned in idx. idx(j) is the index of the data point that is the cluster center for data point j. If idx(j) equals j, then point j is itself a cluster center. The sum of the similarities of the data points to their cluster centers is returned in dpsim, the sum of the preferences of the identified cluster centers is returned in expref and the net similarity (sum of the data point similarities and preferences) is returned in netsim.

A specific example of this code is illustrated below:

```
N=100; x=rand(N,2); % Create N, 2-D data points
M=N*N−N; s=zeros(M,3); % Make ALL N\hat{ }2−N similarities
j=1;
for i=1:N
  for k=[1:i−1,i+1:N]
  s(j,1)=i; s(j,2)=k; s(j,3)=−sum((x(i,:)−x(k,:)).\hat{ }2);
  j=j+1;
  end;
end;
p=median(s(:,3)); % Set preference to median similarity
[idx,netsim,dpsim,expref]=apcluster(s,p,‘plot’);
fprintf(‘Number of clusters: %d\n’,length(unique(idx)));
fprintf(‘Fitness (net similarity): %f\n’,netsim);
figure; % Make a figures showing the data and the clusters
for i=unique(idx)’
  ii=find(idx==i); h=plot(x(ii,1),x(ii,2),‘o’); hold on;
  col=rand(1,3); set(h,‘Color’,col,‘MarkerFaceColor’,col);
  xi1=x(i,1)*ones(size(ii)); xi2=x(i,2)*ones(size(ii));
  line([x(ii,1),xi1]‘,[x(ii,2),xi2]’,‘Color’,col);
end;
axis equal tight;
```

### PARAMETERS

[idx,netsim,dpsim,expref]=apcluster(s,p,‘NAME’,VALUE, . . . )
The following parameters can be set by providing name-value pairs, eg, apcluster(s,p,‘maxits’,1000):

| Parameter | Value |
|---|---|
| ‘sparse’ | No value needed. Use when the number of data points is large (eg, >3000). |
| | Normally, APCLUSTER passes messages between every pair of data points. This |
| | flag causes APCLUSTER to pass messages between pairs of points only if their |
| | input similarity is provided and is not equal to −Inf. |
| ‘maxits’ | Any positive integer. This specifies the maximum number of iterations performed by |
| | affinity propagation. Default: 500. |
| ‘convits’ | Any positive integer. APCLUSTER decides that the algorithm has converged if the |
| | estimated cluster centers stay fixed for convits iterations. Increase this value to apply |
| | a more stringent convergence test. Default: 50. |
| ‘dampfact’ | A real number that is less than 1 and greater than or equal to 0.5. This sets the |
| | damping level of the message-passing method, where values close to 1 correspond to |
| | heavy damping which may be needed if oscillations occur. |
| ‘plot’ | No value needed. This creates a figure that plots the net similarity after each |
| | iteration of the method. If the net similarity fails to converge, consider increasing the |
| | values of dampfact and maxits. |
| ‘details’ | No value needed. This causes idx, netsim, dpsim and expref to be stored after each |
| | iteration. |
| ‘nonoise’ | No value needed. Degenerate input similarities (e.g., where the similarity of i to k |
| | equals the similarity of k to i) can prevent convergence. To avoid this, APCLUSTER |
| | adds a small amount of noise to the input similarities. This flag turns off the addition |
| | of noise. |

This code is copyrighted by Brendan J. Frey and Delbert Dueck (2006).

```
function [idx,netsim,dpsim,expref]=apcluster(s,p,varargin);
  Handle arguments to function
if nargin<2 error(‘Too few input arguments’);
else
  maxits=500; convits=50; lam=0.5; plt=0; details=0; nonoise=0;
  i=1;
  while i<=length(varargin)
    if strcmp(varargin{i},‘plot’)
      plt=1; i=i+1;
    elseif strcmp(varargin{i},‘details’)
      details=1; i=i+1;
              elseif strcmp(varargin{i},‘sparse’)
                      [idx,netsim,dpsim,expref]=
                      apcluster_sparse(s,p,varargin{:});
                      return;
    elseif strcmp(varargin{i},‘nonoise’)
      nonoise=1; i=i+1;
    elseif strcmp(varargin{i},‘maxits’)
      maxits=varargin{i+1};
      i=i+2;
      if maxits<=0 error(‘maxits must be a positive integer’); end;
    elseif strcmp(varargin{i},‘convits’)
      convits=varargin{i+1};
      i=i+2;
      if convits<=0 error(‘convits must be a positive integer’); end;
    elseif strcmp(varargin{i},‘dampfact’)
      lam=varargin{i+1};
      i=i+2;
      if (lam<0.5)||(lam>=1)
        error(‘dampfact must be >= 0.5 and < 1’);
      end;
    else i=i+1;
    end;
  end;
end;
if lam>0.9
  fprintf(‘\n*** Warning: Large damping factor in use. Turn on
  plotting\n’);
  fprintf(‘ to monitor the net similarity. The algorithm will\n’);
  fprintf(‘ change decisions slowly, so consider using a larger value\n’);
  fprintf(‘ of convits.\n\n’);
end;
Check that standard arguments are consistent in size
if length(size(s))~=2 error(‘s should be a 2D matrix’);
elseif length(size(p))>2 error(‘p should be a vector or a scalar’);
elseif size(s,2)==3
  tmp=max(max(s(:,1)),max(s(:,2)));
  if length(p)==1 N=tmp; else N=length(p); end;
  if tmp>N
    error(‘data point index exceeds number of data points’);
  elseif min(min(s(:,1)),min(s(:,2)))<=0
    error(‘data point indices must be >= 1’);
  end;
elseif size(s,1)==size(s,2)
  N=size(s,1);
  if (length(p)~=N)&&(length(p)~=1)
    error(‘p should be scalar or a vector of size N’);
  end;
else error(‘s must have 3 columns or be square’); end;
  Construct similarity matrix
if N>3000
  fprintf(‘\n*** Warning: Large memory request. Consider activating\n’);
  fprintf(‘ the sparse version of APCLUSTER.\n\n’);
end;
if size(s,2)==3
  S=−Inf*ones(N,N);
  for j=1:size(s,1) S(s(j,1),s(j,2))=s(j,3); end;
else S=s;
end;
  In case user did not remove degeneracies from the input similarities,
avoid degenerate solutions by adding a small amount of noise to the
input similarities if ~nonoise
  rns=randn(‘state’); randn(‘state’,0);
  S=S+(eps*S+realmin*100).*rand(N,N);
  randn(‘state’,rns);
end;
  Place preferences on the diagonal of S
if length(p)==1 for i=1:N S(i,i)=p; end;
else for i=1:N S(i,i)=p(i); end;
end;
Allocate space for messages, etc
dS=diag(S); A=zeros(N,N); R=zeros(N,N); t=1;
if plt netsim=zeros(1,maxits+1); end;
if details
  idx=zeros(N,maxits+1);
  netsim=zeros(1,maxits+1);
  dpsim=zeros(1,maxits+1);
  expref=zeros(1,maxits+1);
end;
  Execute parallel affinity propagation updates
e=zeros(N,convits); dn=0; i=0;
while ~dn
  i=i+1;
  Compute responsibilities
  Rold=R;
  AS=A+S; [Y,I]=max(AS,[ ],2); for k=1:N AS(k,I(k))=−realmax; end;
  [Y2,I2]=max(AS,[ ],2);
  R=S−repmat(Y,[1,N]);
  for k=1:N R(k,I(k))=S(k,I(k))−Y2(k); end;
  R=(1−lam)*R+lam*Rold; % Damping
    Compute availabilities
  Aold=A;
  Rp=max(R,0);
  for k=1:N Rp(k,k)=R(k,k); end;
  A=repmat(sum(Rp,1),[N,1])−Rp;
  dA=diag(A); A=min(A,0); for k=1:N A(k,k)=dA(k); end;
  A=(1−lam)*A+lam*Aold; % Damping
    Check for convergence
  E=((diag(A)+diag(R))>0); e(:,mod(i−1,convits)+1)=E; K=sum(E);
  if i>=convits || i>=maxits
    se=sum(e,2);
    unconverged=(sum((se==convits)+(se==0))~=N);
    if (~unconverged&&(K>0))||(i==maxits) dn=1; end;
  end;
    Handle plotting and storage of details, if requested
  if plt||details
    if K==0
      tmpnetsim=nan; tmpdpsim=nan; tmpexpref=nan; tmpidx=nan;
    else
      I=find(E); [tmp c]=max(S(:,I),[ ],2); c(I)=1:K; tmpidx=I(c);
      tmpnetsim=sum(S((tmpidx−1)*N+[1:N]′));
      tmpexpref=sum(dS(I)); tmpdpsim=tmpnetsim−tmpexpref;
    end;
  end;
  if details
    netsim(i)=tmpnetsim; dpsim(i)=tmpdpsim; expref(i)=tmpexpref;
    idx(:,i)=tmpidx;
  end;
  if plt
    netsim(i)=tmpnetsim;
    figure(234);
    tmp=1:i; tmpi=find(~isnan(netsim(1:i)));
    plot(tmp(tmpi),netsim(tmpi),‘r−’);
    xlabel(‘# Iterations’);
    ylabel(‘Fitness (net similarity) of quantized intermediate solution’);
    drawnow;
  end;
end;
I=find(diag(A+R)>0); K=length(I); % Identify exemplars
if K>0
  [tmp c]=max(S(:,I),[ ],2); c(I)=1:K; % Identify clusters
  % Refine the final set of exemplars and clusters and return results
  for k=1:K ii=find(c==k); [y j]=max(sum(S(ii,ii),1)); I(k)=ii(j(1)); end;
  [tmp c]=max(S(:,I),[ ],2); c(I)=1:K; tmpidx=I(c);
  tmpnetsim=sum(S((tmpidx−1)*N+[1:N]′)); tmpexpref=sum(dS(I));
else
  tmpidx=nan*ones(N,1); tmpnetsim=nan; tmpexpref=nan;
end;
if details
  netsim(i+1)=tmpnetsim; netsim=netsim(1:i+1);
  dpsim(i+1)=tmpnetsim−tmpexpref; dpsim=dpsim(1:i+1);
  expref(i+1)=tmpexpref; expref=expref(1:i+1);
  idx(:,i+1)=tmpidx; idx=idx(:,1:i+1);
else
  netsim=tmpnetsim; dpsim=tmpnetsim−tmpexpref;
  expref=tmpexpref; idx=tmpidx;
end;
if plt||details
  fprintf(‘\nNumber of identified clusters: %d\n’,K);
  fprintf(‘Fitness (net similarity): %f\n’,tmpnetsim);
  fprintf(‘ Similarities of data points to exemplars: %f\n’,dpsim(end));
  fprintf(‘ Preferences of selected exemplars: %f\n’,tmpexpref);
  fprintf(‘Number of iterations: %d\n\n’,i);
end;
if unconverged
  fprintf(‘\n*** Warning: Algorithm did not converge. The
  similarities\n’);
  fprintf(‘  may contain degeneracies - add noise to the similarities\n’);
  fprintf(‘  to remove degeneracies. To monitor the net similarity,\n’);
  fprintf(‘  activate plotting. Also, consider increasing maxits and\n’);
  fprintf(‘  if necessary dampfact.\n\n’);
end;
```

### Distance

```
function d = distance(a,b)
DISTANCE - computes Euclidean distance matrix
E = distance(A,B)
      A - (D×M) matrix
      B - (D×N) matrix
Returns:
  E - (M×N) Euclidean distances between vectors in A and B
Description :
      This fully vectorized m-file computes the Euclidean distance
      between two vectors by:
        ||A−B|| = sqrt ( ||A||\hat{ }2 + ||B||\hat{ }2 − 2*A.B )
Example :
  A = rand(400,100); B = rand(400,200);
  d = distance(A,B);
Author  : Roland Bunschoten, University of Amsterdam,
Intelligent Autonomous Systems (IAS)
group Kruislaan 403 1098 SJ Amsterdam, tel.(+31)20-5257524
Last Rev : Oct 29 16:35:48 MET DST 1999
Tested  : PC Matlab v5.2 and Solaris Matlab v5.3
Thanx  : Nikos Vlassis
if (nargin ~= 2)
  error(‘Not enough input arguments’);
end
if (size(a,1) ~= size(b,1))
error(‘A and B should be of same dimensionality’);
end
aa=sum(a.*a,1); bb=sum(b.*b,1); ab=a′*b;
original line in this file
d = sqrt(abs(repmat(aa′,[1 size(bb,2)]) + repmat(bb,[size(aa,2) 1]) −
2*ab));
An additional speed up suggested by Markus Buehren
(markus.buehre@Lss.uni-stuttgart.de) on
the comments page at http://tinyurl.com/3byo6
d = sqrt(abs(aa( ones(size(bb,2),1), :)′ + bb( ones(size(aa,2),1), :) −
2*a′*b));
```

In summary, using dynamic network principles, specific alterations in the modularity of the human interactome that were associated with poor outcome in breast cancer were elucidated. Rather than defining a series of isolated hubs, it was found that most hubs identified in this analysis were components of an interconnected network that had modules associated with MAPK, Estrogen and DNA damage signaling, all of which have been implicated in breast cancer. The presence of these components in a dynamic network suggests they coordinate tumour activity related to poor outcome. Proteasome and RNA processing were the other two major modules identified in this network. Consistent with the notion that aberrant organization of modules is important in cancer progression, many components of the proteasome are associated with aberrant expression and copy number abnormalities (CNAs) in breast cancer tumours and cell lines^{39, 40}. Moreover, low level CNA genes with significant dosage effects in breast cancer were found to be associated with RNA processing and metabolism⁴⁰. These results suggest that alterations in the modularity of networks associated with cellular metabolism are important targets in breast cancer progression. The impact of altered modularity on breast cancer outcome defined in this study provides compelling impetus for the systematic development of multi-modal therapies aimed at targeting multiple nodes in this altered network, rather than individual hubs.

Employing a network modularity signature led to clustering of patients into prognostic groups more accurately than previous microarray investigations of breast cancer samples²⁶. For example, in the current analysis the prognosis accuracy was 76.1% compared to 64% accuracy in previous studies with the same patient sample²⁶. The positive predictive value of the analysis is 81.25%, with a sensitivity of 86.1%. This increase in accuracy was not restricted to the optimized cutoffs employed during clustering (p≦0.09 and k≧7), as similar increases in prognostic accuracy (73.3%) were observed for naïve settings (k≦5 and p≦0.05), suggesting that the parameters have not been overfit. Indeed, analysis of a distinct cohort revealed similar, if not enhanced performance. The favourable performance of the classification algorithms further suggests that changes in network modularity are a defining feature of tumour phenotype that, in turn, determines patient prognosis.

A network modularity signature was able to predict outcome in breast cancer without taking into consideration molecular subtype³. The molecular subtype signature may also be incorporated into the modularity analysis as well as other mechanisms controlling network dynamics, such as alterations in protein levels and phosphorylation-dependent changes in protein-protein interactions.

The present invention is not to be limited in scope by the specific embodiments described herein, since such embodiments are intended as but single illustrations of one aspect of the invention and any functionally equivalent embodiments are within the scope of this invention. Indeed, various modifications of the invention in addition to those shown and described herein will become apparent to those skilled in the art from the foregoing description and accompanying drawings. Such modifications are intended to fall within the scope of the appended claims.

All publications, patents and patent applications referred to herein, as well as priority document U.S. Provisional Patent Application No. 61/104,328, are incorporated by reference in their entirety to the same extent as if each individual publication, patent or patent application was specifically and individually indicated to be incorporated by reference in its entirety. All publications, patents and patent applications mentioned herein are incorporated herein by reference for the purpose of describing and disclosing the methodologies, reagents, etc. which are reported therein which might be used in connection with the invention. Nothing herein is to be construed as an admission that the invention is not entitled to antedate such disclosure by virtue of prior invention.

### REFERENCES

1. Weston, A. D. & Hood, L. Systems biology, proteomics, and the future of health care: toward predictive, preventative, and personalized medicine. Journal of proteome research 3, 179-196 (2004).
2. van't Veer, L. J. et al. Gene expression profiling predicts clinical outcome of breast cancer. Nature 415, 530-536 (2002).
3. Perou, C. M. et al. Molecular portraits of human breast tumours. Nature 406, 747-752 (2000).
4. Chang, H. Y. et al. Gene expression signature of fibroblast serum response predicts human cancer progression: similarities between tumors and wounds. PLoS Biol 2, E7 (2004).
5. Fan, C. et al. Concordance among gene-expression-based predictors for breast cancer. N Engl J Med 355, 560-569 (2006).
6. Pujana, M. A. et al. Network modeling links breast cancer susceptibility and centrosome dysfunction. Nat Genet (2007).
7. Chuang, H. Y., et al. Network-based classification of breast cancer metastasis. Mol Syst Biol 3, 140 (2007).
8. Su, A. I. et al. A gene atlas of the mouse and human protein-encoding transcriptomes. Proc Natl Acad Sci USA 101, 6062-6067 (2004).
9. Brown, K. R. & Jurisica, I. Online predicted human interaction database. Bioinformatics 21, 2076-2082 (2005).
10. von Mering, C. et al. STRING 7-recent developments in the integration and prediction of protein interactions. Nucleic Acids Res 35, D358-362 (2007).
11. Chatr-aryamontri, A. et al. MINT: the Molecular INTeraction database. Nucleic Acids Res 35, D572-574 (2007).
12. Fraser, H. B. Modularity and evolutionary constraint on proteins. Nat Genet. 37, 351-352 (2005).
13. Han, J. D. et al. Evidence for dynamically organized modularity in the yeast protein-protein interaction network. Nature 430, 88-93 (2004).
14. Barabasi, A. L. & Oltvai, Z. N. Network biology: understanding the cell's functional organization. Nature reviews 5, 101-113 (2004).
15. de Lichtenberg, et al., Dynamic complex formation during the yeast cell cycle. Science 307, 724-727 (2005).
16. Tengowski, M. W., et al. Differential expression of genes encoding constitutive and inducible 20S proteasomal core subunits in the testis and epididymis of theophylline- or 1,3-dinitrobenzeneexposed rats. Biol Reprod 76, 149-163 (2007).
17. Thomas, M. K. et al. Bridge-1, a novel PDZ-domain coactivator of E2A-mediated regulation of insulin gene transcription. Mol Cell Biol 19, 8492-8504 (1999).
18. Ashburner, M. et al. Gene ontology: tool for the unification of biology. The Gene Ontology Consortium. Nat. Genet. 25, 25-29 (2000).
19. Yip, K. Y. et al. The tYNA platform for comparative interactomics: a web tool for managing, comparing and mining multiple networks. Bioinformatics 22, 2968-2970 (2006).
20. Hakes, L. et al. Protein-protein interaction networks and biology—what's the connection? Nat Biotechnol 26, 69-72 (2008).
21. Puntervoll, P. et al. ELM server: A new resource for investigating short functional sites in modular eukaryotic proteins. Nucleic Acids Res 31, 3625-3630 (2003).
22. Letunic, I. et al. SMART 5: domains in the context of genomes and networks. Nucleic Acids Res 34, D257-260 (2006).
23. Karnoub, A. E. & Weinberg, R. A. Ras oncogenes: split personalities. Nat Rev Mol Cell Biol 9, 517-531 (2008).
24. McKusick, V. A. Mendelian Inheritance in Man and Its Online Version, OMIM Am J Hum Genet 80, 588-604 (2007).
25. Futreal, P. A. et al. A census of human cancer genes. Nat Rev Cancer 4, 177-183 (2004).
26. van de Vijver, M. J. et al. A gene-expression signature as a predictor of survival in breast cancer. N Engl J Med 347, 1999-2009 (2002).
27. Roukos, D. H. Prognosis of breast cancer in carriers of BRCA1 and BRCA2 mutations. N Engl J Med 357, 1555-1556; author reply 1556 (2007).
28. Soderlund, K. et al. Intact Mre11/Rad50/Nbs1 complex predicts good response to radiotherapy in early breast cancer. Int J Radiat Oncol Biol Phys 68, 50-58 (2007).
29. Easton, D. F. et al. Genome-wide association study identifies novel breast cancer susceptibility loci. Nature 447, 1087-1093 (2007).
30. Liu, R. et al. The prognostic role of a gene signature from tumorigenic breast cancer cells. N Engl J Med 356, 217-226 (2007).
31. Sortie, T. et al. Repeated observation of breast tumor subtypes in independent gene expression data sets. Proc Natl Acad Sci USA 100, 8418-8423 (2003).
32. Tusher, V. G., et al. Significance analysis of microarrays applied to the ionizing radiation response. Proc Natl Acad Sci USA 98, 5116-5121 (2001).
33. Buyse, M. et al. Validation and clinical utility of a 70-gene prognostic signature for women with node-negative breast cancer. J Natl Cancer Inst 98, 1183-1192 (2006).
34. Paik, S. et al. A multigene assay to predict recurrence of tamoxifen-treated, node-negative breast cancer. N Engl J Med 351, 2817-2826 (2004).
35. Singletary, S. E. & Greene, F. L. Revision of breast cancer staging: the 6th edition of the TNM Classification. Semin Surg Oncol 21, 53-59 (2003).
36. Wang, Y. et al. Gene-expression profiles to predict distant metastasis of lymphnode-negative primary breast cancer. Lancet 365, 671-679 (2005).
37. Sotiriou, C. et al. Gene expression profiling in breast cancer: understanding the molecular basis of histologic grade to improve prognosis. J Natl Cancer Inst 98, 262-272 (2006).
38. Haibe-Kains, B. et al. Comparison of prognostic gene expression signatures for breast cancer. BMC genomics 9, 394 (2008).
39. Neve, R. M. et al. A collection of breast cancer cell lines for the study of functionally distinct cancer subtypes. Cancer Cell 10, 515-527 (2006).
40. Chin, K. et al. Genomic and transcriptional aberrations linked to breast cancer pathophysiologies. Cancer Cell 10, 529-541 (2006).
41. von Mering, C. et al. Comparative assessment of large-scale data sets of protein-protein interactions. Nature 417, 399-403 (2002).
42. Shannon, P. et al. Cytoscape: a software environment for integrated models of biomolecular interaction networks. Genome Res 13, 2498-2504 (2003).
43. Lord, P. W., et al. Investigating semantic similarity measures across the Gene Ontology: the relationship between sequence and annotation. Bioinformatics 19, 1275-1283 (2003).
44. Frey, B. J. & Dueck, D. Clustering by passing messages between data points. Science 315, 972-976 (2007).
45. Lin, D. in 15th International Conference on Machine Learning (1998).
46. Linding, R. et al. Systematic Discovery of In Vivo Phosphorylation Networks. Cell (2007).
47. Linding, R. et al. GlobPlot: Exploring protein sequences for globularity and disorder. Nucleic Acids Res 31, 3701-3708 (2003).
48. Goh et al, Skeleton and Fractal Scaling in Complex Networks, Phys. Rev. Ltrs., 96:018701-1-018701-4 (2006).
49. Taylor, I. W. et al, Dynamic modularity in protein interaction networks predicts breast cancer outcome. Nat.Biotech., 27(2):199-204 (2009).

1. A method for diagnosing a subject for the presence of a biological state, a disease or disease stage comprising:
(a) obtaining a biological sample from said subject;
(b) detecting the expression levels of a hub protein and an interacting partner in said sample;
(c) determining the relative expression of said hub protein and said interacting partner in said sample; and
(d) comparing the subject's relative expression to a standard or model to diagnose the subject.

2. The method of claim 1, further comprising repeating (c) for additional interacting partners with said hub protein, and for additional hub proteins and their interacting partners, to generate a subject-specific network signature useful in identifying said biological state, disease or disease stage.

3. The method of claim 1, wherein (b) or (c) further comprises transforming the expression levels of a hub protein and an interacting partner, or relative expression, into numerical or graphical form.

4. The method of claim 1, wherein (c) or (d) is performed by a computer processor.

5. The method of claim 4, which employs the computer program of Example 3.

6. The method of claim 1, wherein said standard or model is a network signature characteristic of a biological state, a disease or disease stage in a reference population.

7. The method of claim 1, wherein said standard or model is a subject-specific network signature of the same subject generated from a temporally earlier biological sample.

8. A method for generating a network signature identifying a biological state, a disease or disease stage, comprising:
(a) obtaining gene expression levels from a reference population having two different biological states, diseases or disease stages;
(b) dividing said reference population gene expression levels into two groups, each group characteristic of one said different biological state, disease or disease stage; and
(c) assessing differences in relative gene expression levels between a hub protein and an interacting partner in said groups to identify a hub protein whose expression relative to an interacting partner is characteristic of one said biological state, disease or disease stage.

9. The method of claim 8, further comprising repeating (c) for additional interacting partners with said hub protein, and for additional hub proteins and their interacting partners, to generate a network signature useful in identifying a biological state, disease or disease stage.

10. The method of claim 8, wherein (c) comprises:
(i) matching each expression level to a hub protein or an interacting partner protein of said hub protein;
(ii) obtaining the Pearson correlation coefficient (r) for each hub protein using the following equation:
$${r}_{A , D} = ( \frac{\sum ( {I}_{A} - \overline{I} ) ( {H}_{A} - \overline{H} )}{( {n}_{A} - 1 ) {s}_{{I}_{A}} {s}_{{H}_{A}}} ) - ( \frac{\sum ( {I}_{D} - \overline{I} ) ( {H}_{D} - \overline{H} )}{( {n}_{D} - 1 ) {s}_{{I}_{D}} {s}_{{H}_{D}}} )$$
wherein:
“I” denotes the amount of expression of an interacting partner,
“H” denotes the amount of expression of a hub protein,
“A” denotes the group of subjects having one biological state, disease or disease stage,
“D” denotes the group of subjects having a different biological state, disease or disease stage,
“nA or nD” denotes the number of subjects in each group, and “S1A and S1D” are the products of the standard deviations of the hub protein and the interacting partner expression for the respective groups; and
(iii) determining if the deviation between rA,D for the two groups is significant, wherein a significant deviation reflects a characteristic hub protein for a biological state, disease or disease stage.

11. The method of claim 8, wherein (a) further comprises transforming the gene expression levels into a numerical or graphical form.

12. The method of claim 8, wherein (b) or (c) is performed by a computer processor.

13. The method of claim 12, wherein the method employs the computer program of Example 3.

14. A computer system, computer program, or computer-readable medium for performing the method of claim 1.

15. A system comprising a computer processor capable of processing gene expression data for a hub protein and its interacting partners, an input device, an output device, and a memory capable of storing computer-readable instructions, wherein the contents of the memory comprises computer-readable instructions that if executed are capable of directing the computer to:
(a) receive gene expression level data from a biological sample from a subject;
(b) determine the relative expression of a hub protein and an interacting partner in said sample;
(c) compare the relative expression to a standard or model; and
(d) output an indication of the presence of a biological state, a disease or disease stage, likelihood thereof, or prognosis therefor.

16. The system of claim 15, further comprising repeating (b) and (c) for additional interacting partners with said hub protein, and for additional hub proteins and their interacting partners.

17. The system of claim 15, wherein said indication is a network signature or subset thereof characteristic of a biological state, a disease, or a disease stage.

18. (canceled)

19. The system of claim 15, wherein said computer-readable instructions comprise the computer program of Example 3.

20-25. (canceled)

26. A computer system, computer program, or computer-readable medium for performing the method of claim 8.
